(19) United States
(12) Patent Application Publication
(10) Pub. No.: US 2017/0130843 A1
(43) Pub. Date: May 11, 2017

(54) Gap-Sub and Measurement While Drilling Assemblies Using Kerros Ringed Gasket Spacers

(71) Applicants: Ranjit K. SINGH, Houston, TX (US); Daniel Maurice LERNER, Missouri City, TX (US); Andrew LERNER, Houston, TX (US); Andre ORBAN, Sugar Land, TX (US); AOI (Advanced Oilfield Innovations, Inc.), Stafford, TX (US)

(72) Inventors: Ranjit K. Singh, Houston, TX (US); Daniel Maurice Lerner, Missouri City, TX (US); Andrew Lerner, Houston, TX (US); Andre Orban, Sugar Land, TX (US)

(21) Appl. No.: 15/322,671

(22) PCT Filed: Jul. 30, 2015
(86) PCT No.: PCT/US2015/042970

§ 371 Date: Dec. 28, 2016

Related U.S. Application Data
(63) Continuation of application No. PCT/US15/38052, filed on Jun. 26, 2015.
(60) Provisional application No. 62/019,143, filed on Jun. 30, 2014.
(60) Provisional application No. 62/031,354, filed on Jul. 31, 2014.
(60) Provisional application No. 62/031,341, filed on Jul. 31, 2014.

(51) Int. Cl. F16J 15/12; F16J 15/10; E21B 47/01; E21B 17/00; E21B 19/16; E21B 17/042

(52) U.S. Cl. CPC F16J 15/122; E21B 19/16; E21B 17/042; E21B 47/011; E21B 17/003; F16J 15/102

(57) ABSTRACT

One or more jointed sub-assemblies with a non-conductive multi-layered ringed spacer gasket mating one or more joints of gap and/or MWD (measurement-while-drilling) sub-assemblies using a ringed spacer gasket is described. The gasket comprises at least two mutually joined ring-shaped bodies, each having a top surface portion, a top gasket section bonded with, adhered to, or part of the top surface portion, a bottom surface portion, and a bottom gasket section bonded with, adhered to, or part of the bottom surface portion wherein the bottom surface portion of one of the bodies is mated to a top surface portion of another of the bodies forming multi-layers; whereby at least two mutually joined ringed-shaped bodies in combination comprise a ringed spacer gasket that also seals one or more jointed sub-assemblies, so that the top and bottom gasket section along with the top and bottom surface portion have equal dimensioned outer diameters with a total thickness no greater than the diameter of the sub-assembly in each sub-assembly half-mated by the gasket. The ringed spacer gasket can be comprised of a metal and the bottom gasket section is separated from the top gasket section by an inner portion that is comprised of one or more non-conductive materials that are ductile but do not flow during dynamic motion and forces associated with the motion of the sub-assembly joints wherein at least one layer of the inner portion includes rings with toroidal wrapped fibers having voids filled with adhesives such that shear forces occurring during movement of the sub-assembly are distributed predominantly in the tensile direction along the axial length of the fibers, thereby eliminating cracking of the gasket under excessive loads.

### PRIORITY

This application is a United States National Phase filing under 35 USC 371 of PCT International application number PCT/US2015/042970 filed Jul. 30, 2014 entitled “Gap-Sub and Measurement While Drilling Assemblies Using Kerros Ringed Gasket Spacers”, which is an international filing of and claims priority to U.S. provisional applications 62/031,354, filed Jul. 31, 2014 and entitled “Measurement While Drilling Gap-Sub with Kerros Ringed Gasket Spacer Assembly”, 62/031,341, filed Jul. 31, 2014 and entitled “Gap-Sub and Kerros Ringed Gasket Spacer Assembly”, and is also a continuation of 62/019,143, filed Jun. 30, 2014 and corresponding PCT application, PCT/US2015/038052, filed Jun. 26, 2015, both entitled“Kerros or Layered Non-Conductive Ringed Sealing Pancake Gasket Assembly”

### FIELD OF INVENTION

This application relates to an improved gap sub-assembly apparatus for facilitating measuring borehole data and for transmitting the data to the surface for inspection and analysis. More specifically, the invention relates generally to an assembled ringed spacer and method of assembling the gap sub-assembly apparatus to join, seal, and provide an electrically non-conductive section located between two portions of the gap-sub-assembly. The word “kerros” is derived from the Finnish word for a ring and more specifically for a layered ring. In this instance, the layered non-conductive ringed gasket sealing assembly is used for jointed sub-assemblies designed for drilling, measuring, completion, and production tubing in hydrocarbon producing wells that cannot tolerate either electrical continuity or fluid leakage. The ringed spacer gasket must be capable of withstanding high tensile and compressive pressures applied both from the exterior and the interior of the two sections of the sub-assembly joint.

This application also relates to an improved gap MWD sub-assembly apparatus for facilitating measurement while drilling (MWD) borehole data and for transmitting the data to the surface for inspection and analysis. More specifically, the invention relates generally to an assembled ringed gasket spacer and method of assembling the measurement while drilling (MWD) gap MWD sub-assembly apparatus to join, seal, and provide an electrically non-conductive section located between two portions of the gap-MWD sub-assembly. In this instance, the layered non-conductive ringed gasket (sealing) assembly is used for jointed sub-assemblies designed for measuring while drilling in hydrocarbon producing wells that cannot tolerate either electrical continuity or fluid leakage. The ringed spacer gasket must be capable of withstanding high tensile and compressive pressures applied both from the exterior and the interior of the two sections of the MWD sub-assembly.

### BACKGROUND

Although the subject invention may find substantial utility at any stage in the life of a borehole, a primary application is in providing real time transmission of large quantities of data simultaneously while drilling. This concept is frequently referred to in the art as downhole measuring while drilling or simply measuring while drilling (MWD). One application is in providing real time transmission of large quantities of data during measurement while drilling. This concept is frequently referred to in the art as downhole measuring while drilling or simply measuring while drilling (MWD).

The incentives for downhole measurements during drilling operations are substantial. Downhole measurements while drilling allow safer, more efficient, and more economic drilling of both exploration and production of hydrocarbon producing wells.

Continuous monitoring of downhole conditions will allow immediate response to potential well control problems. This will allow better mud programs and more accurate selection of casing seats, possibly eliminating the need for an intermediate casing string, or a liner. It also will eliminate costly drilling interruptions while circulating to look for hydrocarbon shows at drilling breaks, or while logs are run to try to predict abnormal pressure zones.

Drilling will be faster and cheaper as a result of real time measurement of parameters such as bit weight, torque, wear and bearing condition. The faster penetration rate, better trip planning, reduced equipment failures, delays for directional surveys, and elimination of a need to interrupt drilling for abnormal pressure detection, could lead to a 5 to 15% improvement in overall drilling rate.

In addition, downhole measurements while drilling may reduce costs for consumables, such as drilling fluids and bits, and may even help avoid setting pipe too early. Were MWD to allow elimination of a single string of casing, further savings could be achieved since smaller holes could be drilled to reach the objective horizon. Since the time for drilling a well could be substantially reduced, more wells per year could be drilled with available rigs. The savings described would be free capital for further exploration and development of energy resources.

Knowledge of subsurface formations will be improved. Downhole measurements while drilling will allow more accurate selection of zones for coring, and pertinent information on formations will be obtained while the formation is freshly penetrated and least affected by mud filtrate. Furthermore, decisions regarding completing and testing a well can be made sooner and more competently.

There are two principal functions to be performed by a continuous MWD system: (1) downhole measurements, and (2) data transmission.

The subject invention pertains to an element of the data transmission aspect of MWD. In the past several systems have been at least theorized to provide transmission of downhole data. These prior systems may be descriptively characterized as: (1) mud pressure pulse, (2) insulated conductor, (3) acoustic and (4) electromagnetic waves.

In a mud pressure pulse system the resistance to the flow of mud through a drill string is modulated by means of a valve and control mechanism mounted in a special drill collar sub near the bit.

The communication speed is fast since the pressure pulse travels up the mud column at or near the velocity of sound in the mud, or about 4,000 to 5,000 fps. However, the rate of transmission of measurements is relatively slow due to pulse spreading, modulation rate limitations, and other disruptive limitations such as the requirement of transmitting data in a fairly noisy environment.

Insulated conductors, or hard wire connection from the bit to the surface, is an alternative method for establishing down hole communications. The advantages of wire or cable systems are that: (1) capability of a high data rate; (2) power can be sent down hole; and (3) two way communication is possible. This type of system has at least two disadvantages; it requires a wireline installed in or attached to the drill pipe and it requires changes in usual rig operating equipment and procedures.

One hardwire method is to run an electrical connector cable to mate with sensors in a drill collar sub. The trade off or disadvantage of this arrangement is the need to withdraw the cable, then replace it each time a joint of drill pipe is added to the drill string. In this and similar systems the insulated conductor is prone to failure as a result of the abrasive conditions of the mud system and the wear caused by the rotation of the drill string. Also, cable techniques usually entail awkward handling problems, especially during adding or removing joints of drill pipe.

As previously indicated, transmission of acoustic or seismic signals through a drill pipe, mud column, or the earth offers another possibility for communication. In such systems an acoustic (or seismic) generator would be located near the bit. Power for this generator has to be supplied downhole. The very low intensity of signals generated downhole, along with the acoustic noise generated by the drilling system, causes difficulties in signal detection. Reflective and refractive interference resulting from changing diameters and thread makeup at the tool joints further compounds the signal attenuation problem for drill pipe transmission. Moreover signal-to-noise limitations for each acoustic transmission path are not well defined using this methodology and associated technology.

Another well-known and major technique comprises the transmission of electromagnetic waves through a drill pipe and the earth. This technique employs electromagnetic pulses carrying downhole data which are transmitted uphole by connecting the electrical transmitter to the two sides of the insulating gap sub-assembly. A receiver is connected to the ground at the surface. In some systems there is an uphole and downhole transceiver that supports bidirectional communications.

It is essential to provide an insulation gap in the drill collar for withstanding severe environmental loading. Thus, the devices providing the conductive drill collar are known in the industry as “gap sub-assemblies”. Such systems are described, for example by U.S. Pat. Nos. 4,349,672 and 4,496,174, the contents of which are hereby incorporated by reference.

The problems and unachieved desires set forth in the foregoing are not intended to be exhaustive but rather are representative of the severe difficulties in the art of transmitting borehole data. Other problems may also exist but those presented above should be sufficient to demonstrate that room for significant improvement remains in the art of transmitting borehole data through the gap sub-assemblies.

In addition to the problems defined above, it has become prevalent in the oil and gas exploration and drilling industry to provide the ability to drill in directions other than vertical as the drilling operation proceeds. Within the last 10 years (as of the date of this application), drilling in the vertical direction is followed by turning the drill bit as the drilling proceeds below, for example, 5000 feet, and for the next 5,000-15,000 feet, the drilling is performed in a mostly perpendicular to vertical direction—in other words—in a horizontal direction through the geological formation. As this turning in direction of the drill bit and sub-assembly occurs, it is the “turning the corner” from the vertical to the horizontal direction which causes extreme stresses to occur within the aforementioned insulation gap. Getting around the corner with the gap sub-assembly without failing, until now, has been difficult, if not impossible to achieve.

One rather unreliable alternative is to just provide a gap in the conventional sub-assembly by providing one or more ceramic spacer rings within this gap. These spacer rings act as washers providing shock absorption to relieve the torsional bending, tensile, and compressive stresses that eventually lead to metal fatigue and eventual metal failure during cyclic drilling operations.

Ceramic is a material that can withstand enormous compressive loads, often in excess of steel and other metals, and is an insulator, and it was a good first choice for making these spacer rings. Ceramics, however, are notoriously brittle and failure of ceramics and ceramic composites usually occur due to imperfections that in the presence of cyclic loads and stresses cause cracks that propagate due to stress fracture. This eventually leads to catastrophic failure in that the spacer rings disintegrate and no longer provide their intended purpose of keeping the necessary insulative gap within the sub-assembly.

In fact, this is exactly the phenomenon being witnessed in the present day-to-day well drilling operations. More specifically, the operators on the drill rig loose electrical connectivity, due to the gap sub-assembly shorting out as the ceramic spacer rings fail in the downhole application.

Often this occurs during the period of time when the turn is being made from vertical to horizontal drilling. The frequency of the occurrence and the associated failure mode varies with the formation, the angle and speed of drilling, and other variables such as pressure, temperature, friction, etc. Additionally, when the spacer rings fail, there is no longer support for an insulated normally threaded pin that extends from one end of the sub-assembly into a box that connects the gap sub-assembly. In other words, this also leads to accelerated metal fatigue failure of the pin, which also shortens the life of the gap sub-assembly. Failure downhole is to be avoided at all costs, as it stops drilling operations, which is unacceptable. Loosing electrical signals requires pulling out the assembly from the wellbore, shutting down operations for hours or days. In fact, this is also exactly the phenomenon being witnessed in the present day-to-day well MWD operations. More specifically, the operators on the drill rig loose electrical connectivity, due to the gap MWD sub-assembly shorting out as the ceramic spacer rings fail in the downhole application. Additionally, when the spacer rings fail, there is no longer support for an insulated normally threaded pin that extends from one end of the MWD sub-assembly into a box that connects the gap MWD sub-assembly. In other words, this also leads to accelerated metal fatigue failure of the pin, which also shortens the life of the gap MWD sub-assembly. Failure downhole is to be avoided at all costs, as it stops drilling operations, which is unacceptable. Loosing electrical signals requires pulling out the assembly from the wellbore, often shutting down operations for hours or days.

In the above connection, notwithstanding substantial economic incentives, and significant activity and theories by numerous interests in the industry, applicants are not aware of the existence of any commercially available system for continuous, uninterrupted telemetering while drilling substantial quantities of real time data from a borehole to the surface during changing of the drilling direction around the aforementioned corner and along a horizontal direction without causing the described imminent failure of the gap sub-assembly.

The requirements for using several known types of seal rings for conduit joints that function in high pressure environments are well known. Common to all of these is the fact that they are made of compact and non-compressible material like metal and metal alloys because other types of materials do not meet all of the requirements in tensile or compressive strength properties and therefore will not be as strong as required in the high pressure applications. One disadvantage of using such conventional seal rings and/or gaskets and/or washers, is the fact that the joints in pipelines typically are exposed to thermal work in the material as well as mechanical stress forces resulting in a joint—especially during bending of the sub-assembly. After some time, the joint will begin to leak. Furthermore, when connecting these types of joints with these rings and/or gaskets, the conventional types normally provide little flexibility and if so, in one direction only.

The conventional ringed gaskets are normally constructed of a single layered (single) material. In some cases, as discussed above, ceramics are used when known compressive forces exceed 30,000 psi. If the ceramic ringed spacer gasket is stressed under certain severe conditions, it may stress crack leading to catastrophic failure in that the ringed gasket will not be able to provide either continued insulation between the two sections of the joint and/or sufficient sealing capacity. As also stated above, in a sub-assembly used for example, in servicing hydrocarbon producing wells, there is an additional need to provide gaskets which are insulators that will fail if conduction through the joint occurs. As also stated above, in a MWD sub-assembly there is an additional need to provide gaskets which are insulators that will fail if conduction through the joint occurs.

The purpose of the present invention is to provide a non-conductive ringed sealing and spacer gasket, referred to herein as a “kerros” ringed spacer gasket, that avoids the aforementioned problems in connection with; thermal work in the material in the area around the conduit joints, withstanding full stresses wherein at least one layer includes an inner portion with continuous toroidal axially and radially wrapped polyamide fibers having voids filled with ceramic or otherwise-filled epoxides such that shear forces occurring during movement of the sub-assembly assemblies are distributed predominantly radially along the axial length of the polyamide fibers, thereby forcing the fibers to distribute load in the tensile direction and eliminating cracking of the gasket.

The present invention is directed to the joint formed between carriers of the sub-assembly and their respective bores and the provision of sealing rings for such joints, wherein the sealing rings and adjacent joint surfaces are so configured that the electrical integrity of the joint is formed thereby and is maintained under pressure either from within the joint or exterior to the joint. At the same time, the sub-assembly joint maintains its' self-aligning characteristic. When the joint is put into motion it causes excessive torsional, tensile, compressive, and shear forces that often exceed 100,000 psi in downhole applications. As previously stated, the failures in a gap sub-assembly often occur in directional drilling when the drilling begins to stray from a vertical direction toward a horizontal direction. In order to dampen and/or alleviate the ultimate load failures, it is desirable to use this gasket acting as a spacer or washer between the jointed sub-assembly that is in motion in order to lengthen the time between failures or even to eliminate failures occurring in the joint. By using one or more gaskets, it is possible to add flexural tolerance to a sub-assembly.

### SUMMARY

The present invention includes the use of a non-conductive ringed spacer gasket device in a gap sub-assembly and as a method of assembling the device. The device is herewith referred to as a kerros ringed spacer gasket for the reasons given above. The layered gasket allows for making at least a two-sectioned sub-assembly which is connected by a joint utilizing the device. The gasket, of course, also acts as a spacer within the joint between the at least two two-sectioned sub-assembly. The device and method of using the device provides improved performance when the sub-assembly is required to become configured in “doglegs” or other curved geometries (as opposed to “straight-line” designs). In either vertical or horizontal (downhole or above ground) applications, the device can also improve or even eliminate galvanic corrosion between the at least two sub-assembly sections of the sub-assembly. The kerros ringed spacer gasket also must provide electrical isolation layers, coatings, or surface treatments of conductive metals causing metal oxides, so that a flange (for instance) used to connect the two or more sections of the sub-assembly assembly are electrically isolated. The mechanical requirements are that the kerros ringed spacer gasket must also improve the tolerance of dynamic stresses of the sub-assembly in comparison with, for example, a simpler gasket using only ceramics. These stresses become excessive and destructive during movement of the sub-assembly in a non-vertical or non-horizontal manner. In this way, the gasket provides some dampening and/or cushioning within the joint so that the sub-assembly can still have the durability to function as if it were a single assembly.

Additionally, the present invention includes the use of a non-conductive ringed spacer gasket device in a gap MWD sub-assembly and as a method of assembling the device. The device is herewith referred to as a kerros ringed spacer (sealing) gasket for the reasons given above. The layered gasket allows for making at least a two-sectioned MWD sub-assembly which is connected by a joint utilizing the device. The gasket, of course, also acts as a spacer within the joint between the at least two two-sectioned MWD sub-assembly. The device and method of using the device provides improved performance when the MWD sub-assembly is required to become configured in “doglegs” or other curved geometries (as opposed to “straight-line” designs). In either vertical or horizontal (downhole or above ground) applications, the device can also improve or even eliminate galvanic corrosion between the at least two MWD sub-assembly sections of the MWD sub-assembly. The kerros ringed spacer gasket also must provide electrical isolation layers, coatings, or surface treatments of conductive metals causing metal oxides, so that a flange (for instance) used to connect the two or more sections of the MWD sub-assembly are electrically isolated. The mechanical requirements are that the kerros ringed spacer gasket must also improve the tolerance of dynamic stresses of the MWD sub-assembly in comparison with, for example, a simpler gasket using only ceramics. These stresses become excessive and destructive during movement of the MWD sub-assembly in a non-vertical or non-horizontal manner. In this way, the gasket provides some dampening and/or cushioning within the joint so that the MWD sub-assembly can retain the durability to function as if it were a single assembly. Throughout the remainder of this disclosure, the use of the ringed sealing gasket in both a gap sub assembly and an MWD sub-assembly is warranted.

Therefore, a general object of the present invention is to provide a non-conductive multi-layered ringed spacer gasket for mating one or more joints along one or more sub-assemblies comprising:

one or more jointed sub-assemblies with a non-conductive multi-layered ringed spacer gasket mating one or more joints separated by a gap of the sub-assemblies, the ringed spacer gasket comprising:

at least two mutually joined ring-shaped bodies, the bodies each having a top surface portion, a top gasket section bonded with, adhered to, or part of the top surface portion, a bottom surface portion, and a bottom gasket section bonded with, adhered to, or part of the bottom surface portion wherein the bottom surface portion of one of the bodies is mated to a top surface portion of another of the bodies forming multi-layers;

whereby;

the at least two mutually joined ringed-shaped bodies in combination comprise a spacer ring that also seals the one or more joints, so that the top and bottom gasket section along with the top and bottom surface portion have equal dimensioned outer diameters with a total thickness no greater than the diameter of the sub-assembly in each sub-assembly joint half-mated by the gasket;

and wherein the top and bottom gasket section of the ringed spacer gasket are comprised of a metal and wherein the top and bottom gasket section is separated by an inner portion that is comprised of one or more non-conductive materials wherein the non-conductive materials are in combination with a top and bottom surface of the inner portion and are ductile but do not flow during dynamic motion and forces associated with the motion of the one or more joints;

and wherein the top and bottom gasket sections together form the sealing ring that is adapted for pressure-tight joining of sub-assembly elements and exhibits full metal ductility withstanding compressive, tensile, shear and/or torsional forces greater than or equal to that of dynamic compressive, tensile, shear and/or torsional strength of the one or more joints of said sub-assembly.

The at least one layer of the gasket includes an inner portion with continuous toroidal axially and radially wrapped fibers having voids filled with adhesives such that shear forces occurring during movement of the sub-assembly assemblies are distributed predominantly radially along the axial length of said fibers, thereby forcing the fibers to distribute load in the tensile direction and eliminating cracking of the gasket either before during or after the gasket has been under load or exposed to cyclical loads.

As stated, the at least one layer includes an inner portion that is wrapped with a toroidal pattern with a prepreg or fabric filled with adhesives, wherein the adhesives are epoxides, and wherein the prepeg is manufactured from the group consisting of fibers or films of polyamides, polyimides, polyamideimides, polybenzimidizoles, polyesters, fiberglass and/or biopolymers.

The epoxides may be filled with at least one of the group consisting of: fibers, films, or particles of; ceramics, ceramers, tungsten carbide, silicon carbide, silica including silane bonding agents, silicone polymers, E-glass, polybenzimidizoles, polyetheretherketones, polysulfones, polyetherimides, and fluoropolymers.

The at least one layer includes an inner portion with a cigarette wrapped film or fiber (often using a polyamide) having voids filled with filled epoxides.

In further embodiments the least one layer exists within the inner portion which is covered but not wrapped around with a woven or non-woven polymeric cloth having voids either pre-filled or post-filled with the epoxides.

The at least one layer exists within an inner portion that is covered by filament wound polyamide fibers having voids either pre-filled or post-filled with epoxides. The polyamide could be Kevlar®, a trademarked product of DuPont De Nemours, Inc.

In further embodiments the inner portion comprises a single non-conductive homogenous material layer and/or a non-conductive non-homogenous material layer, a single conductive homogenous material layer, and/or a single conductive non-homogenous material layer.

The gasket has a total thickness that is no greater than the diameter of a sealing groove in each half pipe-joint creating a full joint when mated by the gasket, wherein the sealing groove is located between two sections of the sub-assembly.

In another embodiment, the top and bottom gasket section and inner portion of the gasket are comprised of one or more non-conductive inorganic materials and/or organic materials.

It is also possible that the top and bottom gasket section is configured such that the outer dimensions of at least the top and bottom surface portion exceed that of the inner portion of the gasket. Additionally, the top and bottom gasket section is beveled along at least one outer edge of the top and/or bottom gasket section. Here it is important that the top and bottom gasket section are compressed toward each other; both upon mating with and insertion within at least two sections of the sub-assembly assembly while the sub-assembly assembly is either at rest or in motion.

In yet a further embodiment, the non-conductive materials are anodized metal oxide(s) formed from a metal or metal alloy, the anodization of which can be established by treating the top and bottom surface metal portion of the gasket.

The anodized metal oxide(s) may be formed by anodized spraying, plasma etching, and/or oxidation exposure techniques for the top and bottom metal gasket sections. The non-conductive materials may also comprise one or more layers of a ceramic or an inorganic composite material such as a ceramer and the inner portion may be comprised of only insulated metal rings.

It is further possible that the sealing ring with the top and bottom gasket section along with the top and bottom surface portion includes at least one diameter having dimensions greater than the inner portion of said sealing ring.

Another embodiment of the multi-layered ringed spacer gasket for mating one or more joints along one or more sub-assembly assemblies comprises the top and bottom gasket section of the ringed spacer gasket being manufactured from a non-metal such as a ceramic or ceramer top and bottom section wherein the top and bottom gasket section remain separated by an inner portion that is comprised of one or more non-conductive materials.

Another embodiment of the multi-layered ringed spacer gasket for mating one or more joints along one or more sub-assemblies comprises a top and bottom gasket section that is separated by an inner portion that is comprised of one or more layers which are interlayered with conductive materials wherein the conductive materials are in combination with a top and bottom surface of the inner portion that remains ductile but does not flow during dynamic motion and forces associated with the motion of one or more sub-assembly joints.

A method for mating one or more of the sub-assembly joints using one or more non-conductive ringed spacer gaskets for one or more sub-assemblies is as follows;

having at least two sections of one or more sub-assemblies, one section of which comprises either an insulative pin portion and/or an insulative box portion;

wherein the gaskets have at least two mutually joined ring-shaped bodies, the bodies each with a top surface portion, a top gasket section bonded with, adhered to, or part of the top surface portion, a bottom surface portion, and a bottom gasket section bonded with, adhered to, or part of the bottom surface portion wherein the bottom surface portion of one of the bodies is being mated to a top surface portion of another of the bodies forming multi-layers;

whereby;

the at least two mutually joined ringed-shaped bodies in combination comprise a sealing ring so that the top and bottom gasket section along with the top and bottom surface portion have equal dimensioned outer diameters with a total thickness no greater than the diameter of the sub-assemblies in each joint half-mated by the gaskets;

and wherein the top and bottom gasket section of the ringed spacer gaskets is comprised of a metal or a non-metal such as a ceramic or ceramer and wherein the top and bottom gasket section is separated by an inner portion that is comprised of one or more materials that can be either conductive or non-conductive and wherein the materials being in combination with a top and bottom surface of the inner portion are ductile but do not flow during moving of the sub-assemblies causing dynamic motion and forces associated with the motion of the one or more sub-assembly joints;

and wherein adapting the sealing ring for pressure-tight joining of sub-assembly elements is allowing and exhibiting full metal ductility withstanding compressive, tensile, shear and/or torsional forces greater than or equal to that of dynamic compressive, tensile, shear and/or torsional strength of the one or more sub-assembly joints by;

placing and attaching the ringed spacer gasket between the pin portion and the box portion of one or more sub-assembly joints during mating of the sub-assemblies;

mating each of the joint halves into a single joint thereby sealing the one or more sub-assembly joints.

It is also possible to include ringed spacer gaskets wherein the gaskets are provided between one or more flanged jointed sub-assemblies.

Often a grease or other lubricating and bonding substance is also included in assembling of the joint. In this specific instance, a new composition that combines an adhesive, a lubricating grease and a polyamide cloth (such as Kevlar®) is used.

In addition, one method for mating one or more of the MWD sub-assembly joints includes using one or more non-conductive ringed spacer gaskets for one or more sub-assemblies is as follows;

having at least two sections of one or more sub-assemblies, one section of which comprises either an insulative pin portion and/or an insulative box portion;

wherein the gaskets have at least two mutually joined ring-shaped bodies, the bodies each with a top surface portion, a top gasket section bonded with, adhered to, or part of the top surface portion, a bottom surface portion, and a bottom gasket section bonded with, adhered to, or part of the bottom surface portion wherein the bottom surface portion of one of the bodies is being mated to a top surface portion of another of the bodies forming multi-layers;

whereby;

the at least two mutually joined ringed-shaped bodies in combination comprise a sealing ring so that the top and bottom gasket section along with the top and bottom surface portion have equal dimensioned outer diameters with a total thickness no greater than the diameter of the sub-assemblies in each joint half-mated by the gaskets;

and wherein the top and bottom gasket section of the ringed spacer gaskets is comprised of a metal or a non-metal such as a ceramic or ceramer and wherein the top and bottom gasket section is separated by an inner portion that is comprised of one or more materials that can be either conductive or non-conductive and wherein the materials being in combination with a top and bottom surface of the inner portion are ductile but do not flow during moving of the sub-assemblies causing dynamic motion and forces associated with the motion of the one or more sub-assembly joints;

and wherein adapting the sealing ring for pressure-tight joining of sub-assembly elements is allowing and exhibiting full metal ductility withstanding compressive, tensile, shear and/or torsional forces greater than or equal to that of dynamic compressive, tensile, shear and/or torsional strength of the one or more sub-assembly joints by;

placing and attaching the ringed spacer gasket between the pin portion and the box portion of one or more sub-assembly joints during mating of the sub-assemblies;

mating each of the joint halves into a single joint thereby sealing the one or more sub-assembly joints.

It is also possible that the ringed spacer gaskets of can be provided between one or more flanged jointed MWD sub-assemblies.

### BRIEF DESCRIPTION OF THE DRAWINGS

The present invention has other objects, features and advantages which will become more clearly apparent in connection with the following detailed description of embodiments, taken in conjunction with the appended drawings in which:

FIG. 1 is an isometric projection or view of one ring or one layer which is part or all of an inner portion of a non-conductive ringed pancake spacer gasket manufactured for withstanding high compressive loads using a single non-conductive material such as a ceramic or ceramer.

FIG. 2 is an isometric projection or view depicting one ring or one layer that is similar or identical to FIG. 1 which is part or all of the inner portion of the non-conductive ringed pancake spacer gasket manufactured for withstanding high compressive loads that is wrapped with a woven or non-woven fabric infused with adhesives that may or may not be filled adhesives.

FIG. 3 is one embodiment of an isometric projection or view depicting three rings or three layers of similar or identical to the inner portion(s) shown in FIGS. 1 and 2 sandwiched between two outer rings or layers of the non-conductive ringed pancake spacer gasket manufactured for withstanding high compressive loads that is wrapped with a woven or non-woven fabric infused with adhesives that may or may not be filled adhesives. In this drawing, the outer rings or layers are shown as conductive metal rings or layers.

FIG. 4 is an exploded view of FIG. 3, indicating how both the top and bottom gasket sections (in this case conductive) have three (multi-layered) (in this case insulative) rings wrapped with adhesive infused fabric to complete the non-conductive ringed pancake spacer gasket which in completed form can withstand extreme compressive, shear, tensile and torsional loads applied by using sub-assembly assemblies used in downhole oil and gas completion and drilling applications.

FIG. 5 is a cross-sectional isometric projection of either a top or bottom gasket sections having a top and bottom surface portion which could be comprised of either a conductive or non-conductive material and could be either homogeneous throughout or non-homogeneous.

FIG. 6 is a cross-sectional isometric projection of the top and bottom gasket sections having a top and bottom surface portion covered with a fabric infused with adhesives and is a non-conductive ringed pancake sealing gasket

FIG. 7 is a cross-sectional isometric projection of the top and bottom gasket sections having five (5) mutually joined ring-shaped bodies each of the bodies having a top surface portion, a top gasket section bonded with, adhered to, or part of the top surface portion, a bottom surface portion, and a bottom gasket section bonded with, adhered to, or part of the bottom surface portion wherein the bottom surface portion of each of the bodies is mated to a top surface portion of another of the bodies forming multi-layers where the multi-layers comprise the inner portion of the non-conductive ringed pancake sealing gasket.

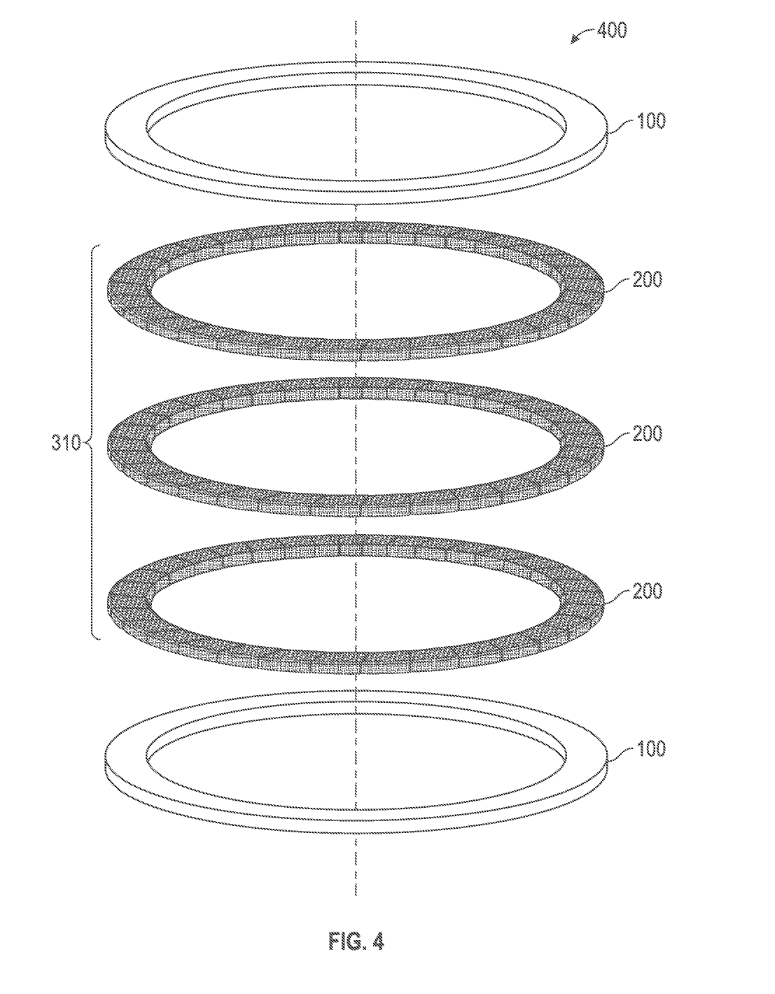

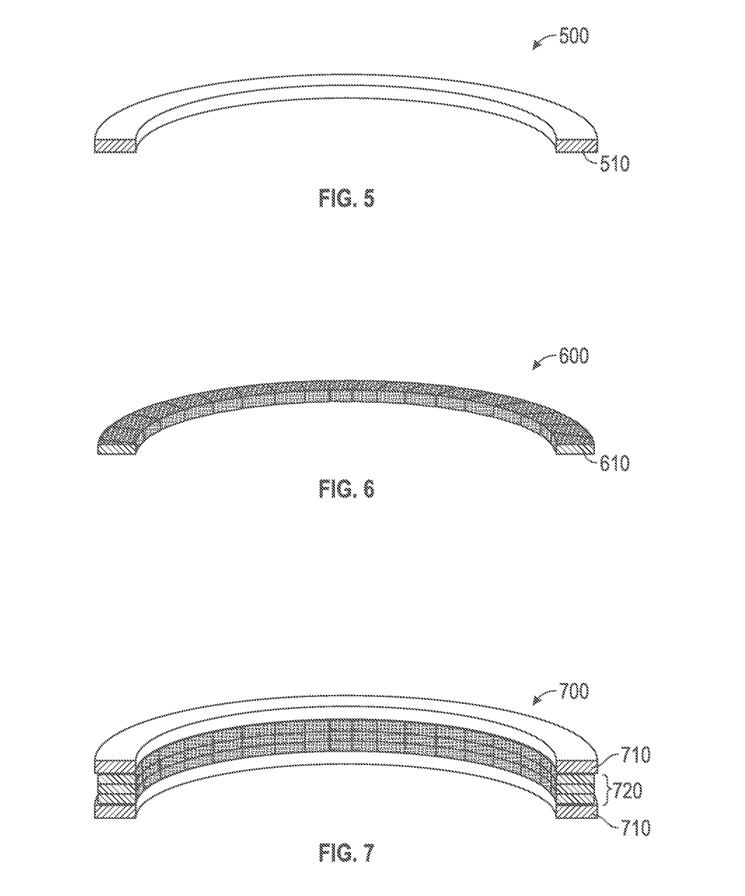

FIGS. 5, 6, and 7, are all cross-sectional isometric views of individual elements which combined have all the elements shown in FIG. 4 thereby arriving at a finished non-conductive ringed pancake sealing gasket.

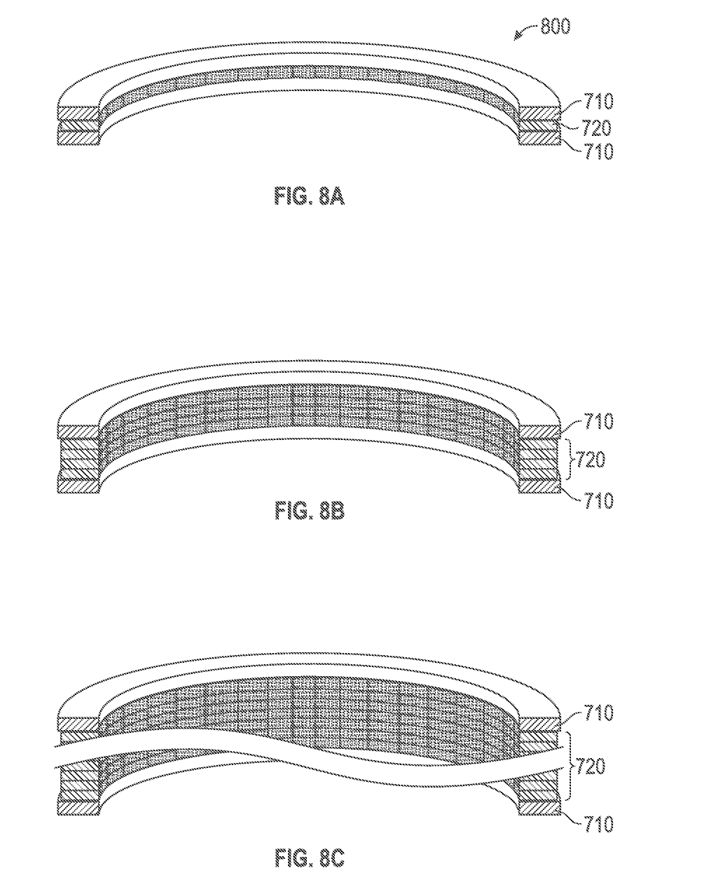

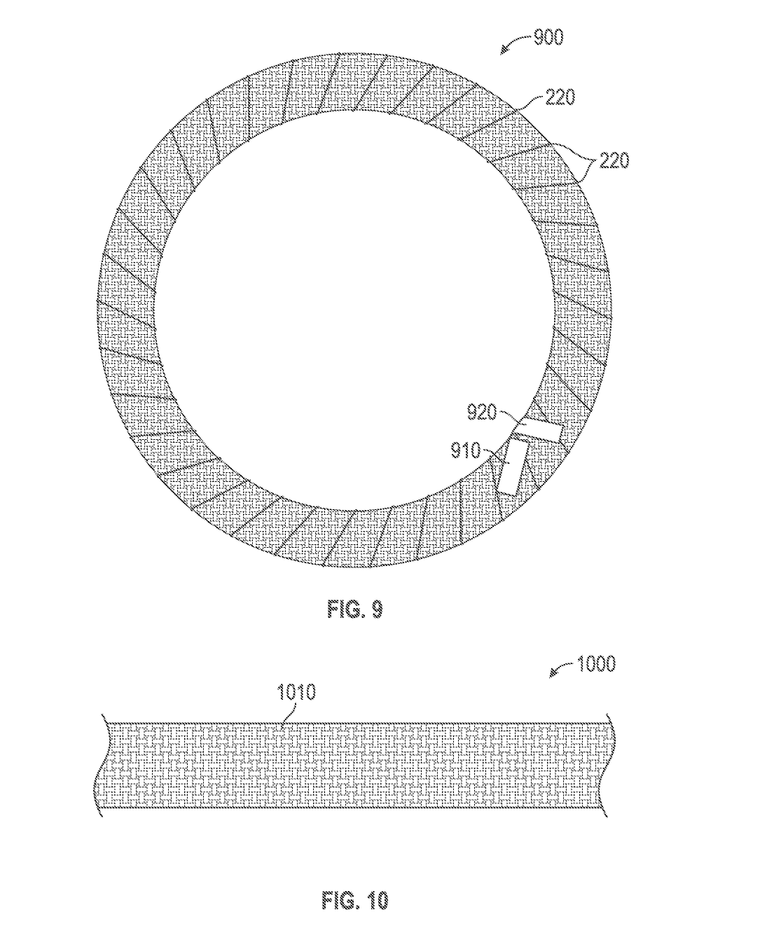

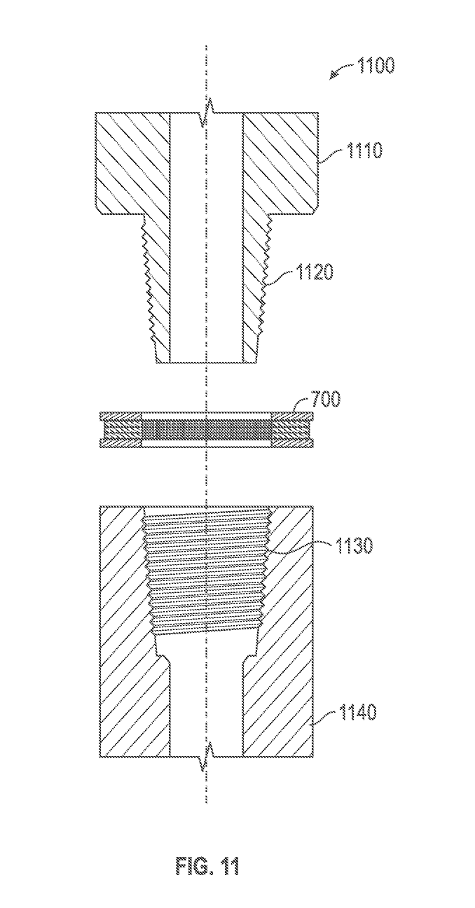

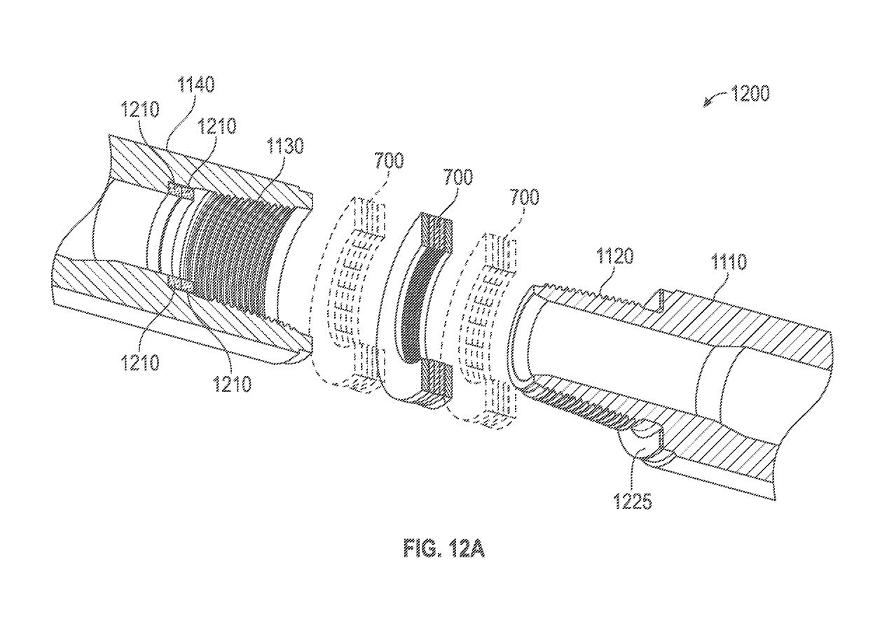

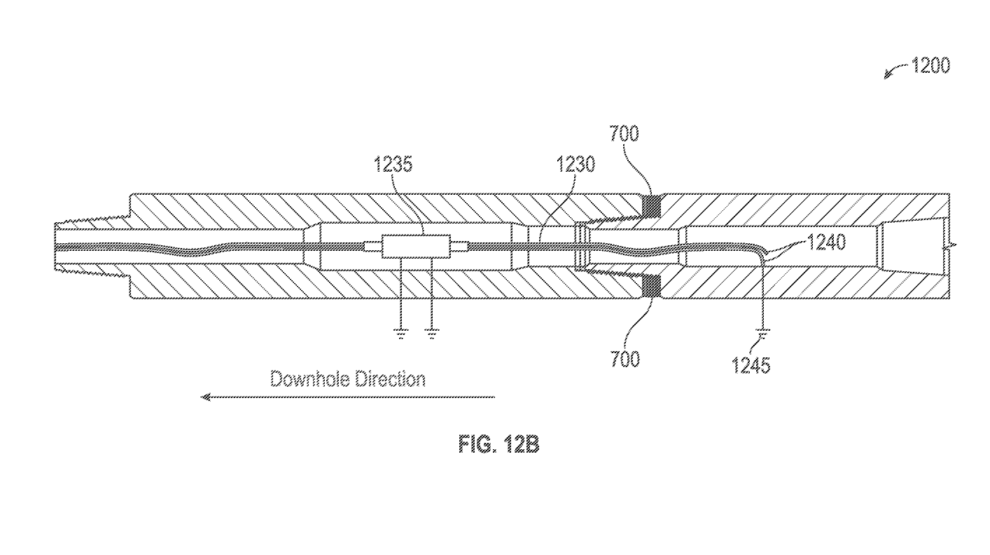

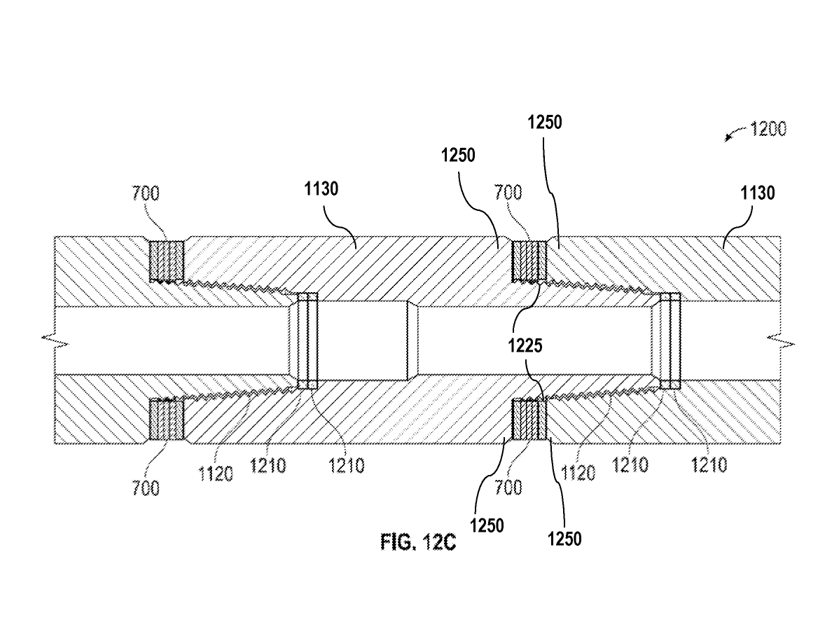

FIGS. 8A, B, and C are all cross-sectional isometric versions of FIG. 7, where the inner portion of the gasket comprises any number of multi-layers residing between a top and bottom gasket section bonded with, adhered to, or part of the bottom surface portion wherein the bottom surface portion of each of the bodies is mated to a top surface portion of another of the bodies with multi-layers where the multi-layers comprise the inner portion of the non-conductive ringed pancake sealing gasket.

FIG. 9 is a schematic top view of FIG. 6, which illustrates an embodiment of the present invention using a toroidal wrapped fabric in the form of a tape with two smaller pieces of adhesive tape used to ensure the wrap is continuous around the top and bottom gasket sections having a top and bottom surface portion covered with the fabric that is either a prepreg or pre or post infused with adhesives.

FIG. 10 is schematic top view of an example of one of the embodiments of the present invention illustrating a patterned fabric such as is used in FIG. 9.

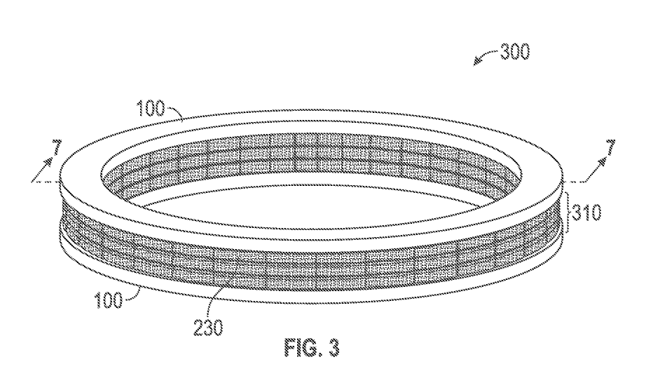

FIG. 11 is schematic cut-away side view of an example of using one of the ringed gaskets of the present invention (as shown for example in FIG. 3) in a gap subassembly.

FIGS. 12 A, B, and C are cross-sectional schematic views of an entire sub-assembly which utilizes one or more ringed (kerros) spacer gaskets within at least one pin and box joint with one or more gaps utilizing the one or more ringed spacer gaskets. The ringed spacer gaskets may be of the same or differing thicknesses as well as varying the pin length and/or box dimensions.

### DETAILED DESCRIPTION

As described in the summary above, the present disclosure provides for a non-conductive ringed spacer (and sealing) gasket within a jointed sub-assembly device, a method of assembling the device and a method of using the device. The device is herewith referred to as a jointed, kerros gasketed sub-assembly for the reasons given above. The gasket is a layered ringed gasket in that one or more layers of material are wrapped or otherwise placed around the gasket. The gasket provides for taking at least a two-sectioned sub-assembly which is connected by a joint utilizing the gasket. It is also possible to have two or more such joints along the length of piping utilized during drilling and/or measuring activities. The gasket acts as a spacer and sealer within the joint between the at least two two-sectioned sub-assembly. The complete device (gasket and sub-assembly) and method of using the device provides improved performance when the sub-assembly is required to become configured in “doglegs” or other curved geometries (as opposed to “straight-line” designs). In either vertical or horizontal (downhole or above ground) applications, the sub-assembly device is also an improvement and can even eliminate galvanic corrosion between the at least two sub-assembly sections of the sub-assembly. The ringed spacer “kerros” gasket also must provide electrical isolation layers, coatings, or surface treatments of conductive metals causing metal oxides, so that a flange (for instance) used to connect the two or more sections of the sub-assembly are electrically isolated. The word “kerros” is derived from the Finnish word for a ring and more specifically for a layered ring. In this instance, the layered ringed gasket is primarily used in jointed sub-assemblies that allow for drilling, measuring, completion, and production tubing in hydrocarbon producing wells. The layered structure of this “kerros” gasket and the method of making the assembled device provides the ability to join two portions of the sub-assembly. It is possible, however, to use the layered ring in essentially any sub-assembly with two or more sections. The mechanical requirements are that the kerros gasket must also improve the tolerance of dynamic stresses of the sub-assembly in comparison with, for example, a simpler gasket using only ceramics. These stresses become excessive and destructive during movement of the sub-assembly in a non-vertical or non-horizontal manner.

In this way, the gasket provides some dampening and/or cushioning within the joint so that the sub-assembly can still have the durability to function as if it were a single assembly. It is necessary to survive pressure on and within the sub-assemblies, and maintain insulative properties during the gasket's lifetime. The purpose of the layered ringed gasket is to provide additional protection to ensure electrical isolation between two sub-assembly sections while at least retaining mechanical strength and in most cases improving joint performance. Ideally, to accomplish this task, one would select a non-conductive metal which meets or exceeds the structural strength integrity of the metal sub-assembly. Non-conductive metals are not simply purchased, thus the necessity for at least a portion of the present invention.

Joint performance using this specially designed kerros gasket is especially improved when the joint is being used for a sub-assembly which is employed in either a static or dynamic manner. The joint is not required to be held in a strictly vertical or horizontal spatial arrangement. The use of the structure of the present invention is substantially unlimited, being applicable wherever a conduit joint requires extremely high compressive and tensile strength so that torsion resulting in shear, compressive, and/or tensile failure cannot occur. This is particularly true in instances wherein the conduit joint may be subjected to high pressures—internally and/or externally.

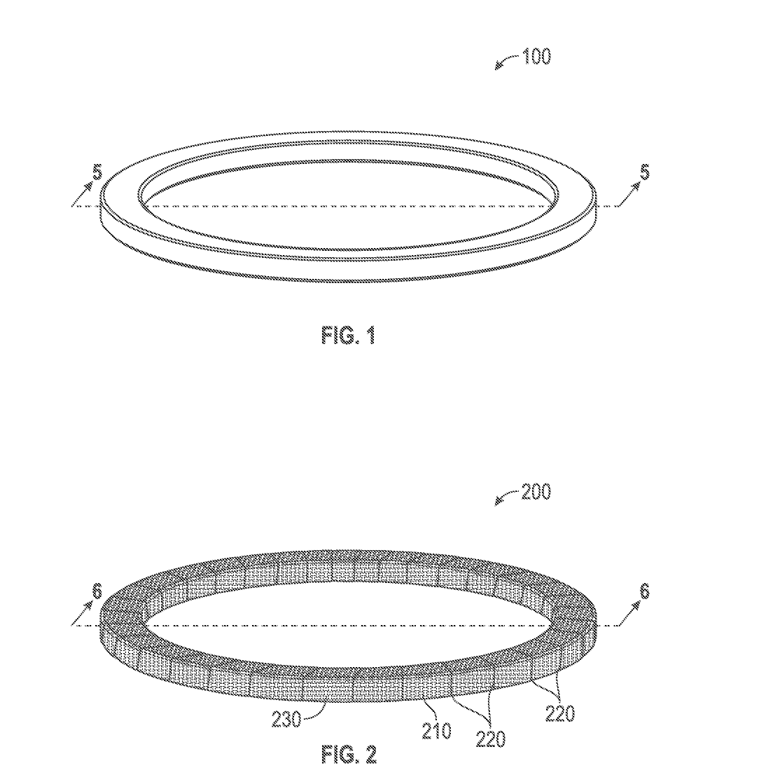

Referring now initially to FIG. 1, shown is an isometric projection or view of one ring with one layer (100) which is part or all of an inner portion of a non-conductive ringed pancake-like spacer gasket manufactured for withstanding high compressive loads using a single non-conductive material such as a ceramic or ceramer. A cross-sectional view of the same is as shown in FIG. 5.

Referring next to FIG. 2, which is an isometric projection or view (200) depicting one ring or one layer (230) that is similar or identical to FIG. 1, the single ring (230) is either a conductive or a non-conductive material which is part of—or all of—the inner portion of the non-conductive ringed pancake spacer gasket manufactured for withstanding high compressive loads. Here, the ring (230) is shown wrapped with a woven or non-woven fabric (210) that may be filled and/or infused with adhesives. The taped fabric (210) version shown is a tightly wrapped toroidal version with seams (220). A cross-sectional version of FIG. 2 is depicted in FIG. 6.

Now referring to FIG. 3, which is one embodiment of an isometric projection or view (300) depicting three layers which comprise an inner portion (310) similar or identical to the inner portion(s) shown in FIGS. 1 and 2. Each ring (230) has a construction similar to that shown in FIG. 2. In this manner, it is possible to use only and simply the ring (230) shown in FIG. 2 as the gasket, if the single ring has full metal ductility as described above. The three layers (310) are sandwiched between two outer rings or layers (100) of the non-conductive ringed pancake spacer gasket manufactured for withstanding high compressive loads that is wrapped with a woven or non-woven fabric infused with adhesives that may or may not be filled adhesives. In this drawing, the outer rings or layers are shown as conductive metal rings or layers. The cross sectional view of this assembly is shown in FIG. 7.

Referring to FIG. 4, which is the same embodiment as shown in FIG. 3, an exploded view of FIG. 3 is shown with all the elements of one of the gaskets to be used in the needed application. These are the outer gasket sections (100), the three rings or layers (200) comprising the inner portion (310). The diagram indicates how both the top and bottom gasket sections (in this case conductive) have three (multi-layered) (in this case insulative) rings wrapped with adhesive infused fabric to complete a non-conductive ringed pancake (like stacked pancakes albeit it of different compositions) sealing gasket. In the completed form, the gasket can withstand extreme compressive, shear, tensile and torsional loads applied by when used within sub-assemblies gaps between joints primarily designed, in some instances, for downhole oil and gas completion and drilling applications.

FIGS. 5, 6, and 7 are all cross-sectional isometric views of individual elements which combined have all the elements shown in FIG. 4 thereby arriving at a finished non-conductive ringed pancake sealing gasket. The cross sections (510), (610), and (710, 720) show homogenous ringed sections, but it is possible that the core of each of the rings shown in FIGS. 5, 6, and 7 could contain non-homogenous materials of construction as well.

FIGS. 8A, 8B, and 8C are all cross-sectional isometric versions (800) of FIG. 7, where the inner portion of the gasket comprises any number of multi-layers (710, 720) residing between a top and bottom gasket section bonded with, adhered to, or part of the bottom surface portion wherein the bottom surface portion of each of the bodies is mated to a top surface portion of another of the bodies with multi-layers where the multi-layers comprise the inner portion of the non-conductive ringed pancake sealing gasket.

FIG. 9 is a schematic top view of FIG. 6 (900) that illustrates an important embodiment of the present invention. The use of the toroidal wrapped fabric with seams in the form of a tape with seams (220) and two smaller pieces of adhesive tape (910, 920) that are used to ensure the wrap is continuous around the top and bottom gasket sections. The gasket has a top and bottom surface portion covered with the fabric that is either a prepreg or pre or post infused with adhesives.

FIG. 10 is simply a schematic top view of one example of one of the embodiments of the present invention illustrating a patterned fabric such as is used in FIG. 9. In this case the pattern is that of a Kevlar® (polyamide) tape which has been subsequently filled or infused with epoxy that has been filled with ceramic.

FIG. 11 is a schematic cut-away side view of an example of using one of the ringed gaskets of the present invention (as shown for example in FIG. 3) in a gap of a sub-assembly (1100). The top bulk section of the body of the sub assembly (1110) includes a threaded female box section (1120) that is distanced from the bulk section of the bottom of the subassembly (1140) having a threaded male pin section (1130) represented with the ringed spacer gasket (700). Insertion of the ringed gasket provides the many functions of the gasket as described herein including dampening the forces and ensuring non-conductivity associated with motion of the joint between the top (1110) and bottom (1140) sections of the subassembly.

FIG. 12A is a schematic exploded cross-sectional view illustrating the joint utilizing multiple ringed spacer gaskets (700) of the gap sub-assembly (1200). As in FIG. 11, the top bulk section of the body of the sub assembly (1110) includes a threaded female or box section (1120) that is distanced from the bulk section of the bottom portion (on the left side of the diagram) of the subassembly (1140) having a threaded male or pin section (1130). Insertion of the ringed spacer gasket(s) provides the many functions of the gasket(s) as described herein including dampening the forces (either static or dynamically generated), ensuring non-conductivity associated with motion of the joint between the top (1110) and bottom (1140) sections of the subassembly. Additionally, shown are inner insulators (1210)—which normally are constructed of ceramic, ceramer, or high temperature rated resistance polymers as the materials of choice —on the box side of the sub-assembly. Also shown, are one or more stress relievers and associated exterior insulation portions (1225) shown on the pin side of the gap sub-assembly (1200).

FIG. 12B is a full cross-sectional view of the entire gap sub-assembly (1200). The purpose of this figure is to illustrate one version of an antennae (1230) supplying electrical connectivity extending through the joint section of the sub-assembly. The figure also helps orient the direction in which the sub-assembly is utilized for downhole wellbore configurations. The antennae as indicated, has both a grounded, insulative section (1235) located in the box portion of the gap sub-assembly and at least two wired ends (1240) that extend into the pin section of the gap-sub assembly. One of the wired ends is shown to also having an earthing ground (1245) as well.

FIG. 12C is a close up of the full cross-sectional view shown in FIG. 12B of the entire gap sub-assembly (1200), but further illustrating multiple gaps in the gap sub-assembly. The purpose of this figure is to illustrate one version of a joint section of the sub assembly utilizing a double ended pinned section. This section has two pin ends (1120) that extent into two respective box ends (1130). It is also possible to provide one or more sections that provide both a pin end (1120) and a box end (1130) to form multiple joints of the gap sub-assembly. Between the shoulders (1250) of the gap sub-assembly (1200) is where the (kerros) ringed gasket (700) resides prior to and during linear and/or torsional compression while in operation. In the case of the present invention, FIG. 12C also represents the test arrangement which assisted in determining functional designs for the ringed gasket. Additionally shown are inner insulators (1210) (normally utilizing ceramic, ceramer, or high temperature resistance rated polymers as the materials of choice) on the box side of the sub-assembly (1200). The threaded female box section (1130) has one or more stress relievers and associated exterior insulation (1225), which are provided and shown on the pin side (1120) of the gap sub-assembly (1200).

It is further instructive to also describe one of many methods of using a single or multiple non-conductive ringed spacer gasket assemblies for mating one or more joints along one or more sub-assemblies as follows;

at least two mutually joined ring-shaped bodies, the bodies each with a top surface portion, a top gasket section bonded with, adhered to, or part of the top surface portion, a bottom surface portion, and a bottom gasket section bonded with, adhered to, or part of the bottom surface portion wherein the bottom surface portion of one of the bodies is being mated to a top surface portion of another of the bodies forming multi-layers so that the at least two mutually joined ringed-shaped bodies in combination comprise a single sealing ring. This is accomplished when the top and bottom gasket section along with the top and bottom surface portion have equal dimensioned outer diameters with a total thickness no greater than the diameter of the sub-assembly in each joint half-mated by the gasket. It is also possible to accomplish this with a design as shown in FIG. 3. The top and bottom gasket section of the ringed spacer gasket can be comprised of a metal or a non-metal such as a ceramic or ceramer and the top and bottom gasket section is separated by an inner portion that is comprised of one or more materials that can be either conductive or non-conductive. These materials being in combination with a top and bottom surface of the inner portion remain ductile but do not flow in order to avoid failure during moving of the sub-assembly causing dynamic motion and forces associated with the motion of one or more pipe joints.

Failure is defined as when any two sections of the sub-assembly become unified sufficiently to cause an electrically conductive circuit to exist through the ringed gasket. Normally this failure can be determined by measuring conductivity from one side of the sub-assembly to the other side or from one side of the gasket to the other side using an ohm meter. If resistivity is measured to be equal to or greater than 10,000 ohms, the gasket is defined as no longer is providing insulative qualities needed for a typical gap sub (also known as the gap sub-assembly or sub-assembly.

Adapting the sealing ring for pressure-tight joining of pipe elements that exhibit “full metal ductility” is a critical design parameter of the gasket. “Full metal ductility” is therefore achieved by using metal rings either for the top and/or bottom gasket sections of the gasket and/or within the inner portion of the gasket. Using ceramics, for example, has been shown to be useful but inferior to the present design, as ceramics have immense compressive strength but lack ductility.

In this aspect of the invention it was known that the use of ceramers (ceramics with reduced compressive strength but improved ductility) would be useful and necessary for the application requirements. It was also determined that a non-conductive metal would be the ideal material property for the needed gasket, but no known non-conductive metal exists. The gasket will only tolerate and withstand excessive compressive, tensile, shear and/or torsional forces greater than or equal to that of dynamic compressive, tensile, shear and/or torsional strength of the one or more pipe joints by placing and attaching the ringed spacer gasket described in detail above. The design and material combinations with layers described herewithin allow for ensuring one or more pipe joints and mating each of the pipe-joint halves into a single joint thereby sealing the joint. The gasket can therefore allow the joint to operate properly, in for example, a gap subassembly used for downhole applications.

### Example

More specifically, for downhole applications using a gap sub-assembly, one example of testing the jointed sub-assembly using the ringed gasket is as follows (comparisons with simple ceramic rings);

A sub-assembly with a kerros ring compression test rig was fabricated so that the ringed spacer gasket could be placed between an “API” threaded joint connection. This test rig arrangement is identical to one portion of FIG. 12 C which illustrates the pin section (1120) and box section (1130) relationship with the ringed gasket (700) being placed in the gap portion between the shoulders (1250) of the gap sub. This rig was fabricated with a single shoulder (1250) to simulate how the ringed gasket would operate in a downhole gap sub-assembly. The gasket joint combination was tested both during static and dynamic loading environments.

In each case, four (4) ringed sealing gaskets prepared from the same fabrication methods using different rings to complete the ringed sealing gasket designs were placed in the rig with the results as shown in tabular form below. The different fabrication methods and rings used to completed the single ringed gasket entity in the joint are also described at the bottom of each table. The results are separated into a total of eight tables.

Tables 1 A-D and 2 A-D regarding both static and dynamic loading testing performed for each of the four separate ringed sealing gaskets. None of the four ringed gaskets completely delaminated or otherwise failed to maintain their mechanical integrity during testing, indicating that all designs are operational, with some functioning better than others. In addition during the static and dynamic loading, none of the rings within the complete ringed gasket were forced to complete an electrical circuit, meaning that they each remained functioning as insulators during the static and dynamic loads that were applied in the compression rig as described above.

Tables 1 A-D indicate the results of compression of the ringed sealing gasket. The data was obtained by sandwiching the gasket between two steel plates that subsequently were pressed together. As the plates were compressed, the compression was measured (in psi) resulting in changes in dimensions of the gasket due to the compression. The compression was accomplished by using a piston press configuration (not shown) that allowed for pulling the steel plates apart so that the gasket could be placed between the plates. Next pumping the piston using a hand pump allowed for compressing the plates between which the gasket resided. As the plates came together, the ringed gasket (and of course all the rings comprising the gasket) were compressed. The changes in the thickness of the ringed gasket were measured by the distance (in inches) remaining between the 2 plates on both sides of the gasket. Data on the resulting decrease in thickness was taken as the pressure was increased. Each table provides information on the construction of each of the ringed gaskets. Each construction for each of the rings of the ringed gaskets for Tables 1 A-D was different.

Tables 2 A-D indicate the results of torsional stress testing provided to the ringed gasket (kerros ring) as follows. Referring back to FIG. 12 C, the ringed gasket (700) was held between the shoulders of the gap sub (1200) so that compression was created when the pin (male section) (1120) was rotationally screwed into the box (female section) section (1130) by using a torque machine (not shown). The torque machine is a simple device that allows for gripping both the pin and box sides as the pin is rotated and inserted into the (in this case) stationary box. In this way the threads are torqued, thereby creating torsional load (measured in ft-lbs). The resulting changes in dimensions due to the torque can therefore be measured by taking readings from a computer aided torque gauge. In Tables 2 A-D, the angular measurements are descriptive of the relative rotation of the pin to the box (assuming the box remains stationary) measured in inches along the outside diameter of the sub-assembly (with an outer diameter of 6.5 inches). In other words, this measurement is the change in the arc length of the resting position after successive torque loads were applied. Data on the resulting decrease in thickness of the gap between the shoulders was taken as the pressure was increased.

Each table (for Examples 1—static and 2—dynamic torsional) provides information on the construction of each of the ringed gaskets. In each case, the ringed gasket spacers (composed of multiple rings) compression tested resulted from wrapping a polyamide, Kevlar® fabric in a toroidal configuration around individual rings located within the ringed sealing gasket that was infused with, in this specific case, an EP 1350 ceramic epoxy adhesive obtained from ResinLab of Germantown, Md. and cured at 90 C or greater for at least 2 hours. After full curing and hardening, the gaskets were readied for testing.

### Example 1: Static Compression Testing with Ringed Sealing Gaskets

TABLE 1A*

| | | Left side | Right side |
|---|---|---|---|
| | PSI # | gap (in) | gap (in) |
| Test #1 | 0 | 0.529 | 0.529 |
| | 1000 | 0.529 | 0.526 |
| | 2000 | 0.528 | 0.524 |
| | 3000 | 0.528 | 0.524 |
| Test #2 | 0 | 0.529 | 0.529 |
| | 1000 | 0.525 | 0.525 |
| | 2000 | 0.522 | 0.521 |
| | 3000 | 0.521 | 0.522-0.524 |

TABLE 1B**

| | | Left side | Right side |
|---|---|---|---|
| | PSI # | gap (in) | gap (in) |
| Test #1 | 0 | 0.466 | 0.467 |
| | 1200 | 0.465 | 0.465 |
| | 2000 | 0.465 | 0.465 |
| | 3000 | 0.464 | 0.464 |
| Test #2 | 0 | 0.466 | 0.467 |
| | 3000 | 0.465 | 0.465 |

**Ringed gasket #2 comprises; two outer rings with 0.062″ thickness (bare Al metal) and two inner rings of 0.125″ thickness each prior to fabrication; Fabrication using toroidal Kevlar ® fabric wrap infused with EP 1350 ceramic epoxy

TABLE 1C***

| | | Left side | Right side |
|---|---|---|---|
| | PSI # | gap (in) | gap (in) |
| Test #1 | 0 | 0.540 | 0.555 |
| | 1000 | 0.534 | 0.544 |
| | 2000 | 0.530 | 0.537 |
| | 3000 | 0.528 | 0.534 |
| Test #2 | 0 | 0.532 | 0.540 |
| | 1000 | 0.530 | 0.536 |
| | 2000 | 0.529 | 0.534 |
| | 3000 | 0.527 | 0.532 |
| Test #3 | 0 | 0.533 | 0.540 |
| | 3000 | 0.527 | 0.532 |

***Ringed gasket #3 comprises; a set of two outer (bare Al metal) rings each with 0.125″ thickness and three (3) 0.062″ thick inner rings each prior to fabrication, using a Kevlar ® toroidal wrap infused with EP 1350 ceramic epoxy that also contains 20 Grit Aluminum oxide particles

TABLE 1D****

| | | | Right |
|---|---|---|---|
| | | Left side | side gap |
| | PSI # | gap (in) | (in) |
| Test #1 | 0 | 0.471 | 0.555 |
| | 1000 | 0.470 | 0.544 |
| | 2000 | 0.470 | 0.537 |
| | 3000 | 0.469 | 0.534 |
| Test #2 | 0 | 0.471 | 0.540 |
| | 3000 | 0.468 | 0.532 |
| Test #3 | 0 | | |
| | 3000 | 0.469 | 0.532 |
| | 0 | 0.471 | 0.465 |

****Ringed gasket #4 comprises two (2) (bare Al metal) 0.125″ outer rings, and two (2) 0.062″ inner rings each prior to fabrication. Fabrication again used a toroidal Kevlar ® wrapping infused with EP 1350 ceramic epoxy

### Example 2: Dynamic Compression Testing with Ringed Sealing Gaskets

TABLE 2A^{†}

| | | | Rotational Dimensional Change |
|---|---|---|---|
| Torque (ft- | Gap- | Gap- | Along Circumference |
| lbs.) | Top | Bottom | of Gap Sub |
| 350 | 0.480 | 0.493 | 0 |
| 5000 | 0.470 | 0.544 | 1⅞″ |
| 10000 | 0.470 | 0.537 | 2⅝″ |
| 15000 | 0.469 | 0.534 | 3⅛″ |
| 20000 | 0.471 | 0.540 | 3¾″ |
| 25000 | 0.468 | 0.532 | 4½″ |

^{†}Initial total ringed gasket #1 thickness was 0.460″ and comprises; 0.062″ thickness for each of 2 outer rings and 0.125″ thickness for an inner ring prior to fabrication with a Kevlar ® toroidal wrap infused with the same EP 1350 epoxy adhesive. During the torsional compression, this ringed gasket began to fail by at least one layer beginning to delaminate at 20,000 psi. Torsional compression, however, was continued up to 25,000 psi. The test rig was then released and a new ringed gasket was inserted.

TABLE 2B^{††}

| | | | Rotational Dimensional |
|---|---|---|---|
| Torque | Gap- | Gap- | Change Along Circumference |
| (ft.lbs.) | Top | Bottom | of Gap Sub |
| 500 | 0.540 | 0.540 | 0 |
| 5000 | 0.536 | 0.531 | 1⅜″ |
| 10000 | 0.527 | 0.520 | 2¼″ |
| 15000 | 0.523 | 0.518 | 3″ |
| 20000 | 0.518 | 0.516 | 3¾″ |
| 25000 | 0.511 | 0.508 | 4½″ |

^{††}Initial total ringed gasket #2 thickness was 0.534″ and comprises; two 0.125″ thick outer rings, and 3 0.062″ inner rings with a toroidal Kevlar ®wrap infused with EP 1350 epoxy ceramic adhesive. At 17,000 psi in torsion, the rings of the ringed gasket began to break away from each other. The final thickness was 0.530″ after break away occurred.

TABLE 2C^{†††}

| | | | Rotational Dimensional |
|---|---|---|---|
| Torque | Gap- | Gap- | Change Along Circumference |
| (ft.lbs.) | Top | Bottom | of Gap Sub |
| 500 | 0.555 | 0.539 | 0 |
| 5000 | 0.534 | 0.530 | 1¾″ |
| 10000 | 0.523 | 0.515 | 3″ |
| 15000 | 0.508 | 0.502 | 4½″ |
| 20000 | 0.485 | 0.490 | 6⅛″ |
| 25000 | 0.470 | 0.485 | 7½″ |

^{†††}Initial gap spacing prior to torque was 0.536/0.545″ (top and bottom). The ringed gasket #3 comprises; two (2) 0.125″ thick outer rings and two (2), 0.062″ thick inner rings prior to fabrication with a toroidal wrap infused with 120 grit aluminum oxide particles mixed in with the ceramic epoxy adhesive. The gap thickness was then measured to be 0.512/0.510″ after the torque test was completed.

TABLE 2D^{††††}

| | | | Rotational Dimensional |
|---|---|---|---|
| Torque | Gap- | Gap- | Change Along Circumference |
| (ft.lbs.) | Top | Bottom | of Gap Sub |
| 500 | 0.489 | 0.486 | 0 |
| 5000 | 0.472 | 0.471 | 1¾″ |
| 10000 | 0.468 | 0.467 | 2⅜″ |
| 15000 | 0.465 | 0.465 | 2⅞″ |
| 20000 | 0.453 | 0.454 | 4″ |
| 25000 | 0.443 | 0.445 | 5″ |

^{††††}Initial gap thickness prior to torque was 0.471″ and after torque was 0.445″. The ringed gasket #4 comprises; two (2) 0.125″ thick outer rings and two (2), 0.062″ thick inner rings prior to fabrication with a toroidal wrap and ceramic epoxy adhesive.

The preceding description of specific embodiments of the present invention is not intended to be a complete list of every possible embodiment of the invention. Persons skilled in this field will recognize that modifications can be made to the specific embodiments described here that would be within the scope of the present invention.

We claim:

1. One or more jointed sub-assemblies with a non-conductive multi-layered ringed spacer gasket mating one or more joints separated by a gap of said sub-assembly, said ringed spacer gasket comprising:
at least two mutually joined ring-shaped bodies, said bodies each having a top surface portion, a top gasket section bonded with, adhered to, or part of said top surface portion, a bottom surface portion, and a bottom gasket section bonded with, adhered to, or part of said bottom surface portion wherein said bottom surface portion of one of said bodies is mated to a top surface portion of another of said bodies forming multi-layers;
whereby;
said at least two mutually joined ringed-shaped bodies in combination comprise a spacer ring that also seals said one or more joints, so that said top and bottom gasket section along with said top and bottom surface portion have equal dimensioned outer diameters with a total thickness no greater than the diameter of said sub-assembly in each sub-assembly joint half-mated by said gasket;
and wherein said top and bottom gasket section of said ringed spacer gasket are comprised of a metal and wherein said top and bottom gasket section is separated by an inner portion that is comprised of one or more non-conductive materials wherein said non-conductive materials are in combination with a top and bottom surface of said inner portion and are ductile but do not flow during dynamic motion and forces associated with said motion of said one or more joints;
and wherein said top and bottom gasket sections together form said ringed sealing gasket that is adapted for pressure-tight joining of sub-assembly elements and exhibits full metal ductility withstanding compressive, tensile, shear and/or torsional forces greater than or equal to that of dynamic compressive, tensile, shear and/or torsional strength of said one or more joints of said sub-assembly.

2. The jointed sub-assemblies of claim 1, wherein said gasket has at least one layer that includes said inner portion with continuous toroidal axially and radially wrapped fibers having voids filled with adhesives such that shear forces occurring during movement of said sub-assemblies are distributed predominantly radially along the axial length of said fibers, thereby forcing said fibers to distribute load in the tensile direction and reducing or eliminating cracking of said gasket.

3. The gasket of claim 2, wherein at least one layer includes said inner portion that is wrapped in a toroidal pattern with a prepreg or fabric filled with said adhesives, wherein said adhesives are epoxides, and wherein said prepeg is manufactured from the group consisting of fibers or films of polyamides, polyimides, polyamideimides, polybenzimidizoles, polyesters, fiberglass and biopolymers.

4. The gasket of claim 3, wherein said epoxides are filled with at least one of the group consisting of: fibers, films, or particles of; ceramics, ceramers, tungsten carbide, silicon carbide, silica including silane bonding agents, silicone polymers, E-glass, polybenzimidizoles, polyetheretherketones, polysulfones, polyetherimides, and fluoropolymers.

5. The gasket of claim 4, wherein at least one layer includes a cigarette wrapped polyamide inner portion having voids filled with said filled epoxides.

6. The gasket of claim 3, wherein at least one layer exists and cover but does not wrap around said inner portion with a woven or non-woven polymeric cloth having voids either pre-filled or post-filled with said epoxides.

7. The gasket of claim 3, wherein at least one layer exists for said inner portion that is covered by filament wound polyamide fibers having voids either pre-filled or post-filled with said epoxides.

8. The gasket of claims 2-7, wherein said polyamide is Kevlar®.

9. The sub-assemblies of claim 1, wherein said inner portion of said gasket section comprises a single non-conductive, homogenous material layer.

10. The sub-assemblies of claim 1, wherein said inner portion of said gasket section comprises a single non-conductive, non-homogenous material layer.

11. The sub-assemblies of claim 1, wherein said inner portion of said gasket section comprises a single conductive homogenous material layer.

12. The sub-assemblies of claim 1, wherein said inner portion of said gasket section comprises a single conductive non-homogenous material layer.

13. The sub-assemblies of claim 1, wherein said total thickness of said gasket is no greater than the diameter of a sealing groove in each half pipe-joint creating a full joint when mated by said gasket, wherein said sealing groove is located between two sections of said sub-assemblies.

14. The sub-assemblies of claim 1, wherein said top and bottom gasket section and said inner portion of said gasket section are comprised of one or more non-conductive inorganic materials.

15. The sub-assemblies of claim 1, wherein said top and bottom gasket section and said inner portion of said gasket section are comprised of one or more non-conductive organic materials.

16. The sub-assemblies of claim 1, wherein said top and bottom gasket section is configured such that outer dimensions of at least said top and bottom surface portion exceeds that of said inner portion of said gasket.

17. The sub-assemblies of claim 1, wherein said top and bottom gasket section is beveled along at least one outer edge of said top and/or bottom gasket section.

18. The sub-assemblies of claim 1, wherein said top and bottom gasket section is compressed toward each other; both upon mating with and insertion within at least two sections of said sub-assembly while said sub-assembly is either at rest or in motion.

19. The sub-assemblies of claim 1, wherein said non-conductive materials of said gasket section are anodized metal oxide(s) formed from a metal or metal alloy, the anodization of which can be established by treating a top and bottom surface metal portion of said gasket section.

20. The sub-assemblies of claim 1, wherein said anodized metal oxide(s) are formed by anodized spraying, plasma etching, and/or oxidation exposure of said top and bottom surface metal portion of said gasket section.

21. The gasket section of claim 14, wherein said non-conductive materials comprise one or more layers of a ceramic or an inorganic composite material such as a ceramer.

22. The sub-assemblies of claim 1, wherein said inner portion of said gasket is comprised of insulated metal rings only.

23. The sub-assemblies of claim 1, wherein said sealing ring with said top and bottom gasket section along with said top and bottom surface metal gasket portion include at least one diameter having dimensions greater than an inner portion of said sealing ring.

24. One or more sub-assemblies with one or more non-conductive multi-layered ringed spacer gaskets for mating one or more sub-assembly joints comprising:
at least two mutually joined ring-shaped bodies, said bodies each having a top surface portion, a top gasket section bonded with, adhered to, or part of said top surface portion, a bottom surface portion, and a bottom gasket section bonded with, adhered to, or part of said bottom surface portion wherein said bottom surface portion of one of said bodies is mated to a top surface portion of another of said bodies forming multi-layers;
whereby;
said at least two mutually joined ringed-shaped bodies in combination comprise a sealing ring so that said top and bottom gasket section along with said top and bottom surface metal portion have equal dimensioned outer diameters with a total thickness no greater than the diameter of said sub-assembly in each joint half-mated by said one or more gaskets;
and wherein said top and bottom gasket section of said ringed spacer gaskets are comprised of a non-metallic ceramic or ceramer top and bottom section and wherein said top and bottom gasket section is separated by an inner portion that is comprised of one or more non-conductive materials wherein said non-conductive materials are in combination with a top and bottom surface of said inner portion and are ductile but do not flow during dynamic motion and forces associated with said motion of said one or more sub-assembly joints;
and wherein said top and bottom gasket sections together form said sealing ring that is adapted for pressure-tight joining of sub-assembly elements and exhibits full metal ductility withstanding compressive, tensile, shear and/or torsional forces greater than or equal to that of dynamic compressive, tensile, shear and/or torsional strength of said one or more sub-assembly joints.

25. The sub-assemblies of claim 24, wherein said gaskets include at least one layer and said inner portion with continuous toroidal axially and radially wrapped fibers having voids filled with adhesives such that shear forces occurring during movement of said sub-assemblies are distributed predominantly radially along the axial length of said polyamide fibers, thereby forcing said fibers to distribute load in the tensile direction and eliminating cracking of said gasket.

26. The gaskets of claim 25, wherein at least one layer includes said inner portion that is wrapped in a toroidal pattern with a prepreg filled with said adhesives, wherein said adhesives are epoxides, and wherein said prepeg or fabric is manufactured from the group consisting of fibers or films of polyamides, polyimides, polyamideimides, polybenzimidizoles, polyesters, fiberglass and biopolymers.

27. The gaskets of claim 26, wherein said epoxides are filled with at least one of the group consisting of: fibers, films, or particles of; ceramics, ceramers, tungsten carbide, silicon carbide, silica including silane bonding agents, silicone polymers, E-glass, polybenzimidizoles, polyetheretherketones, polysulfones, polyetherimides, and fluoropolymers.

28. The gaskets of claims 25-27, wherein at least one layer includes said inner portion with a cigarette wrapped polyamide having voids filled with said filled epoxides.

29. The gaskets of claim 28, wherein at least one layer exists within said inner portion that is covered but not wrapped around with a woven or non-woven polyamide cloth having voids either pre-filled or post-filled with said epoxides.

30. The gaskets of claim 24, wherein at least one layer exists within said inner portion that is covered by filament wound polyamide fibers having voids either pre-filled or post-filled with said epoxides.

31. The sub-assemblies of claims 24-30, wherein said polyamide is Kevlar®.

32. The sub-assemblies of claim 24, wherein said inner portion comprises a single non-conductive homogenous material layer.

33. The sub-assemblies of claim 24, wherein said inner portion comprises a single non-conductive non-homogenous material layer.

34. The sub-assemblies of claim 24, wherein said inner portion comprises a single conductive homogenous material layer.

35. The sub-assemblies of claim 24, wherein said inner portion comprises a single conductive non-homogenous material layer.

36. The sub-assemblies of claim 24, wherein said total thickness of said gaskets is no greater than the diameter of a sealing groove in each half pipe-joint creating a full joint when mated by said gaskets, wherein said sealing groove is located between two sections of said sub-assembly assembly.

37. The sub-assemblies of claim 24, wherein said top and bottom gasket section and said inner portion of said gaskets are comprised of one or more non-conductive inorganic materials.

38. The sub-assemblies of claim 24, wherein said top and bottom gasket section and said inner portion of said gaskets are comprised of one or more non-conductive organic materials.

39. The sub-assemblies of claim 24, wherein said top and bottom gasket section is configured such that the outer dimensions of at least said top and bottom surface portion exceeds that of said inner portion of said gaskets.

40. The sub-assemblies of claim 24, wherein said top and bottom gasket section is beveled along at least one outer edge of said top and/or bottom gasket section.

41. The sub-assemblies of claim 24, wherein said top and bottom gasket section are compressed toward each other; both upon mating with and insertion within at least two sections of said sub-assemblies while said sub-assemblies are either at rest or in motion.

42. The sub-assemblies of claim 24, wherein said non-conductive materials are anodized metal oxide(s) formed from a metal or metal alloy, the anodization of which can be established by treating a top and bottom surface metal portion of said gaskets.

43. The sub-assemblies of claim 24, wherein said anodized metal oxide(s) are formed by anodized spraying, plasma etching, and/or oxidation exposure techniques of said top and bottom metal portion of sections of said gaskets.

44. The sub-assemblies of claim 37, wherein said non-conductive materials comprise one or more layers of a ceramic or an inorganic composite material such as a ceramer.

45. The sub-assemblies of claim 24, wherein said inner portion of said gaskets is comprised of insulated metal rings only.

46. The sub-assemblies of claim 24, wherein said sealing ring with said top and bottom gasket section along with said top and bottom surface portion include at least one diameter having dimensions greater than said inner portion of said sealing ring.

47. One or more non-conductive multi-layered ringed spacer gaskets for mating one or more jointed sub-assemblies comprising:
at least two mutually joined ring-shaped bodies, said bodies each having a top surface portion, a top gasket section bonded with, adhered to, or part of said top surface portion, a bottom surface portion, and a bottom gasket section bonded with, adhered to, or part of said bottom surface portion wherein said bottom surface portion of one of said bodies is mated to a top surface portion of another of said bodies forming multi-layers;
whereby;
said at least two mutually joined ringed-shaped bodies in combination comprise a sealing ring so that said top and bottom gasket section along with said top and bottom surface portion have equal dimensioned outer diameters with a total thickness no greater than the diameter of said sub-assemblies in each joint half-mated by said gaskets;
and wherein said top and bottom gasket section of said ringed spacer gasket are comprised of a metal and wherein said top and bottom gasket section is separated by an inner portion that is comprised of one or more layers which are interlayered with conductive materials wherein said conductive materials are in combination with a top and bottom surface of said inner portion that is ductile but does not flow during dynamic motion and forces associated with said motion of said one or more jointed sub-assemblies;
and wherein said sealing ring is adapted for pressure-tight joining of sub-assembly elements and exhibits full metal ductility withstanding compressive, tensile, shear and/or torsional forces greater than or equal to that of dynamic compressive, tensile, shear and/or torsional strength of said one or more jointed sub-assemblies.

48. The gaskets of claim 47, wherein at least one layer includes said inner portion with continuous toroidal axially and radially wrapped fibers having voids filled with adhesives such that shear forces occurring during movement of said sub-assemblies are distributed predominantly radially along the axial length of said polyamide fibers, thereby forcing said fibers to distribute load in the tensile direction and eliminating cracking of said gaskets.

49. The gaskets of claim 47, wherein at least one layer includes said inner portion that is wrapped in a toroidal pattern with a prepreg filled with said adhesives, wherein said adhesives are epoxides, and wherein said prepeg or fabric is manufactured from the group consisting of fibers or films of polyamides, polyimides, polyamideimides, polybenzimidizoles, polyesters, fiberglass and biopolymers.

50. The gaskets of claim 49, wherein said epoxides are filled with at least one of the group consisting of: fibers, films, or particles of; ceramics, ceramers, tungsten carbide, silicon carbide, silica including silane bonding agents, silicone polymers, E-glass, polybenzimidizoles, polyetheretherketones, polysulfones, polyetherimides, and fluoropolymers.

51. The gaskets of claim 48, wherein at least one layer includes a cigarette wrapped polyamide around said inner portion having voids filled with said filled epoxides.

52. The gaskets of claim 48, wherein at least one layer exists within said inner portion that is covered but not wrapped around with a woven or non-woven polyamide cloth having voids either pre-filled or post-filled with said epoxides.

53. The gaskets of claim 47, wherein at least one layer exists that is covered by filament wound polyamide fibers around said inner portion having voids either pre-filled or post-filled with said epoxides.

54. The gaskets of claims 47-53, wherein said polyamide is Kevlar®.

55. The gaskets of claim 47, wherein said inner portion comprises a single non-conductive homogenous material layer.

56. The gaskets of claim 47, wherein said inner portion comprises a single non-conductive non-homogenous material layer.

57. The gaskets of claim 47, wherein said inner portion comprises a single conductive homogenous material layer.

58. The gaskets of claim 47, wherein said inner portion comprises a single conductive non-homogenous material layer.

59. The gaskets of claim 47, wherein said total thickness is no greater than the diameter of a sealing groove in each half-joint creating a full joint when mated by said gaskets, wherein said sealing groove is located between two sections of said sub-assemblies.

60. The gaskets of claim 47, wherein said top and bottom gasket section and said inner portion of said gaskets are comprised of one or more non-conductive inorganic materials.

61. The gaskets of claim 47, wherein said top and bottom gasket section and said inner portion of said gasket are comprised of one or more non-conductive organic materials.

62. The gaskets of claim 47, wherein said top and bottom gasket section is configured such that the outer dimensions of at least said top and bottom surface portion exceeds that of said inner portion of said gaskets.

63. The gaskets of claim 47, wherein said top and bottom gasket section is beveled along at least one outer edge of said top and/or bottom gasket section.

64. The gaskets of claim 47, wherein said top and bottom gasket section are compressed toward each other; both upon mating with and insertion within at least two sections of said sub-assemblies while said sub-assemblies are either at rest or in motion.

65. The gaskets of claim 47, wherein said non-conductive materials are anodized metal oxide(s) formed from a metal or metal alloy, the anodization of which can be established by treating a top and bottom surface metal portion of said gaskets.

66. The gaskets of claim 47, wherein said anodized metal oxide(s) are formed by anodized spraying, plasma etching, and/or oxidation exposure techniques of top and bottom metal gasket sections.

67. The gaskets of claim 61, wherein said non-conductive materials comprise one or more layers of a ceramic or an inorganic composite material such as a ceramer.

68. The method of claim 47, wherein said inner portion is comprised of only insulated metal rings.

69. The method of claim 47, wherein said sealing ring with said top and bottom gasket section along with said top and bottom surface portion include at least one diameter having dimensions greater than said inner portion of said sealing ring.

70. A method of mating one or more sub-assembly joints using one or more non-conductive ringed spacer gaskets for one or more sub-assemblies comprising:
having at least two sections of one or more sub-assemblies, one section of which comprises either an insulative pin portion and/or an insulative box portion;
wherein said gaskets have at least two mutually joined ring-shaped bodies, said bodies each with a top surface portion, a top gasket section bonded with, adhered to, or part of said top surface portion, a bottom surface portion, and a bottom gasket section bonded with, adhered to, or part of said bottom surface portion wherein said bottom surface portion of one of said bodies is being mated to a top surface portion of another of said bodies forming multi-layers;
whereby;
said at least two mutually joined ringed-shaped bodies in combination comprise a sealing ring so that said top and bottom gasket section along with said top and bottom surface portion have equal dimensioned outer diameters with a total thickness no greater than the diameter of said sub-assemblies in each joint half-mated by said gaskets;
and wherein said top and bottom gasket section of said ringed spacer gaskets is comprised of a metal or a non-metal such as a ceramic or ceramer and wherein said top and bottom gasket section is separated by an inner portion that is comprised of one or more materials that can be either conductive or non-conductive and wherein said materials being in combination with a top and bottom surface of said inner portion are ductile but do not flow during moving of said sub-assemblies causing dynamic motion and forces associated with said motion of said one or more sub-assembly joints;
and wherein adapting said sealing ring for pressure-tight joining of sub-assembly elements is allowing and exhibiting full metal ductility withstanding compressive, tensile, shear and/or torsional forces greater than or equal to that of dynamic compressive, tensile, shear and/or torsional strength of said one or more sub-assembly joints by;
placing and attaching said ringed spacer gasket between said pin portion and said box portion of one or more sub-assembly joints during mating of said sub-assemblies;
mating each of the joint halves into a single joint thereby sealing said one or more sub-assembly joints.

71. The method of claim 70, wherein at least one layer includes said inner portion with continuous toroidal axially and radially wrapped polyamide fibers having voids filled with ceramic-filled epoxides such that shear forces occurring during movement of said sub-assemblies are distributed predominantly radially along the axial length of said polyamide fibers, thereby forcing said fibers to distribute load in the tensile direction and eliminating cracking of said gaskets.

72. The method of claim 70, wherein at least one layer includes said inner portion with continuous toroidal axially and radially wrapped fibers having voids filled with adhesives such that shear forces occurring during movement of said sub-assemblies are distributed predominantly radially along the axial length of said polyamide fibers, thereby forcing said fibers to distribute load in the tensile direction and reducing or eliminating cracking of said gaskets.

73. The method of claim 70, wherein at least one layer includes said inner portion that is wrapped in a toroidal pattern with a prepreg filled with said adhesives, wherein said adhesives are epoxides, and wherein said prepeg or fabric is manufactured from the group consisting of fibers or films of polyamides, polyimides, polyamideimides, polybenzimidizoles, polyesters, fiberglass and biopolymers.

74. The method of claim 73, wherein said epoxides are filled with at least one of the group consisting of: fibers, films, or particles of; ceramics, ceramers, tungsten carbide, silicon carbide, silica including silane bonding agents, silicone polymers, E-glass, polybenzimidizoles, polyetheretherketones, polysulfones, polyetherimides, and fluoropolymers.

75. The method of claim 71, wherein at least one layer exists within said inner portion that is covered but not wrapped around with a woven or non-woven polyamide cloth having voids either pre-filled or post-filled with said epoxides.

76. The method of claim 75, wherein at least one layer exists within said inner portion being covered by filament wound polyamide fibers having voids either pre-filled or post-filled with said epoxides.

77. The method of claims 70-76, wherein said polyamide is Kevlar®.

78. The method of claim 70, wherein said inner portion comprises a single non-conductive homogenous material layer.

79. The method of claim 70, wherein said inner portion comprises a single non-conductive non-homogenous material layer.

80. The method of claim 70, wherein said inner portion comprises a single conductive homogenous material layer.

81. The method of claim 70, wherein said inner portion comprises a single conductive non-homogenous material layer.

82. The method of claim 70, wherein said total thickness is no greater than the diameter of a sealing groove in each half-joint creating a full joint when mated by said gasket, wherein said sealing groove is located between two sections of said sub-assembly.

83. The method of claim 70, wherein said top and bottom gasket section and said inner portion of said gasket are comprised of one or more non-conductive inorganic materials.

84. The method of claim 70, wherein said top and bottom gasket section and said inner portion of said gasket are comprised of one or more non-conductive organic materials.

85. The method of claim 70, wherein said top and bottom gasket section is configured such that the outer dimensions of at least said top and bottom surface portion exceeds that of said inner portion of said gasket.

86. The method of claim 70, wherein said top and bottom gasket section is beveled along at least one outer edge of said top and/or bottom gasket section.

87. The method of claim 70, wherein said top and bottom gasket section are compressed toward each other; both upon mating with and insertion within at least two sections of said sub-assemblies while said sub-assemblies are either at rest or in motion.

88. The method of claim 70, wherein said non-conductive materials are anodized metal oxide(s) formed from a metal or metal alloy, the anodization of which can be established by treating a top and bottom surface metal portion of said gaskets.

89. The method of claim 70, wherein said anodized metal oxide(s) are formed by anodized spraying, plasma etching, and/or oxidation exposure techniques of top and bottom metal surface sections of said gaskets.

90. The gasket of claim 83, wherein said non-conductive materials comprise one or more layers of a ceramic or an inorganic composite material such as a ceramer.

91. The method of claim 70, wherein said inner portion is comprised of only insulated metal rings.

92. The method of claim 70, wherein said sealing ring with said top and bottom gasket section along with said top and bottom surface portion include at least one diameter having dimensions greater than said inner portion of said sealing ring.

93. The ringed spacer gaskets of claims 1 and 47 wherein said gaskets are provided between one or more flanged jointed sub-assemblies.

94. One or more jointed measurement while drilling (MWD) sub-assemblies with a non-conductive multi-layered ringed spacer gasket mating one or more joints of said MWD sub-assembly, said ringed spacer gasket comprising:
at least two mutually joined ring-shaped bodies, said bodies each having a top surface portion, a top gasket section bonded with, adhered to, or part of said top surface portion, a bottom surface portion, and a bottom gasket section bonded with, adhered to, or part of said bottom surface portion wherein said bottom surface portion of one of said bodies is mated to a top surface portion of another of said bodies forming multi-layers;
whereby;
said at least two mutually joined ringed-shaped bodies in combination comprise a spacer ring that also seals said one or more joints, so that said top and bottom gasket section along with said top and bottom surface portion have equal dimensioned outer diameters with a total thickness no greater than the diameter of said MWD sub-assembly in each MWD sub-assembly joint half-mated by said gasket;
and wherein said top and bottom gasket section of said ringed spacer gasket are comprised of a metal and wherein said top and bottom gasket section is separated by an inner portion that is comprised of one or more non-conductive materials wherein said non-conductive materials are in combination with a top and bottom surface of said inner portion and are ductile but do not flow during dynamic motion and forces associated with said motion of said one or more joints;
and wherein said top and bottom gasket sections together form said sealing ring that is adapted for pressure-tight joining of MWD sub-assembly elements and exhibits full metal ductility withstanding compressive, tensile, shear and/or torsional forces greater than or equal to that of dynamic compressive, tensile, shear and/or torsional strength of said one or more joints of said MWD sub-assembly.

95. The jointed MWD sub-assemblies of claim 94, wherein said gasket has at least one layer that includes said inner portion with continuous toroidal axially and radially wrapped fibers having voids filled with adhesives such that shear forces occurring during movement of said sub-assemblies are distributed predominantly radially along the axial length of said fibers, thereby forcing said fibers to distribute load in the tensile direction and eliminating cracking of said gasket.

96. The gasket of claim 95, wherein at least one layer includes said inner portion that is wrapped in a toroidal pattern with a prepreg or fabric filled with said adhesives, wherein said adhesives are epoxides, and wherein said prepeg is manufactured from the group consisting of fibers or films of polyamides, polyimides, polyamideimides, polybenzimidizoles, polyesters, fiberglass and biopolymers.

97. The gasket of claim 96, wherein said epoxides are filled with at least one of the group consisting of: fibers, films, or particles of; ceramics, ceramers, tungsten carbide, silicon carbide, silica including silane bonding agents, silicone polymers, E-glass, polybenzimidizoles, polyetheretherketones, polysulfones, polyetherimides, and fluoropolymers.

98. The gasket of claim 96, wherein at least one layer includes said inner portion with a cigarette wrapped polyamide having voids filled with said filled epoxides.

99. The gasket of claim 95, wherein at least one layer exists within said inner portion that is covered but not wrapped around with a woven or non-woven polymeric cloth having voids either pre-filled or post-filled with said epoxides.

100. The gasket of claim 95, wherein at least one layer exists within said inner portion that is covered by filament wound polyamide fibers having voids either pre-filled or post-filled with said epoxides.

101. The gasket of claims 94-100, wherein said polyamide is Kevlar®.

102. The sub-assemblies of claim 94, wherein said inner portion of said gasket section comprises a single non-conductive, homogenous material layer.

103. The sub-assemblies of claim 94, wherein said inner portion of said gasket section comprises a single non-conductive, non-homogenous material layer.

104. The sub-assemblies of claim 94, wherein said inner portion of said gasket section comprises a single conductive homogenous material layer.

105. The sub-assemblies of claim 94, wherein said inner portion of said gasket section comprises a single conductive non-homogenous material layer.

106. The sub-assemblies of claim 94, wherein said total thickness of said gasket is no greater than the diameter of a sealing groove in each half pipe-joint creating a full joint when mated by said gasket, wherein said sealing groove is located between two sections of said sub-assemblies.

107. The sub-assemblies of claim 94, wherein said top and bottom gasket section and said inner portion of said gasket section are comprised of one or more non-conductive inorganic materials.

108. The sub-assemblies of claim 94, wherein said top and bottom gasket section and said inner portion of said gasket section are comprised of one or more non-conductive organic materials.

109. The sub-assemblies of claim 94, wherein said top and bottom gasket section is configured such that the outer dimensions of at least said top and bottom surface portion exceeds that of said inner portion of said gasket.

110. The sub-assemblies of claim 94, wherein said top and bottom gasket section is beveled along at least one outer edge of said top and/or bottom gasket section.

111. The sub-assemblies of claim 94, wherein said top and bottom gasket section are compressed toward each other; both upon mating with and insertion within at least two sections of said MWD sub-assembly while said MWD sub-assembly is either at rest or in motion.

112. The sub-assemblies of claim 94, wherein said non-conductive materials of said gasket section are anodized metal oxide(s) formed from a metal or metal alloy, the anodization of which can be established by treating said top and bottom surface metal portion of said gasket section.

113. The MWD sub-assemblies of claim 94, wherein said anodized metal oxide(s) are formed by anodized spraying, plasma etching, and/or oxidation exposure techniques of top and bottom metal gasket sections.

114. The gasket section of claim 94, wherein said non-conductive materials comprise one or more layers of a ceramic or an inorganic composite material such as a ceramer.

115. The MWD sub-assemblies of claim 94, wherein said inner portion of said gasket is comprised of only insulated metal rings.

116. The MWD sub-assemblies of claim 94, wherein said sealing ring with said top and bottom gasket section along with said top and bottom surface portion include at least one diameter having dimensions greater than an inner portion of said sealing ring.

117. One or more MWD sub-assemblies with one or more non-conductive multi-layered ringed spacer gaskets for mating one or more MWD sub-assembly joints comprising:
at least two mutually joined ring-shaped bodies, said bodies each having a top surface portion, a top gasket section bonded with, adhered to, or part of said top surface portion, a bottom surface portion, and a bottom gasket section bonded with, adhered to, or part of said bottom surface portion wherein said bottom surface portion of one of said bodies is mated to a top surface portion of another of said bodies forming multi-layers;
whereby;
said at least two mutually joined ringed-shaped bodies in combination comprise a sealing ring so that said top and bottom gasket section along with said top and bottom surface portion have equal dimensioned outer diameters with a total thickness no greater than the diameter of said MWD sub-assembly in each joint half-mated by said one or more gaskets;
and wherein said top and bottom gasket section of said ringed spacer gaskets are comprised of a non-metallic ceramic or ceramer top and bottom section and wherein said top and bottom gasket section is separated by an inner portion that is comprised of one or more non-conductive materials wherein said non-conductive materials are in combination with a top and bottom surface of said inner portion and are ductile but do not flow during dynamic motion and forces associated with said motion of said one or more MWD sub-assembly joints;
and wherein said top and bottom gasket sections together form said sealing ring that is adapted for pressure-tight joining of MWD sub-assembly elements and exhibits full metal ductility withstanding compressive, tensile, shear and/or torsional forces greater than or equal to that of dynamic compressive, tensile, shear and/or torsional strength of said one or more MWD sub-assembly joints.

118. The MWD sub-assemblies of claim 117, wherein said gaskets include at least one layer and said inner portion with continuous toroidal axially and radially wrapped fibers having voids filled with adhesives such that shear forces occurring during movement of said sub-assemblies are distributed predominantly radially along the axial length of said polyamide fibers, thereby forcing said fibers to distribute load in the tensile direction and eliminating cracking of said gasket.

119. The gaskets of claim 118, wherein at least one layer includes said inner portion that is wrapped in a toroidal pattern with a prepreg filled with said adhesives, wherein said adhesives are epoxides, and wherein said prepeg or fabric is manufactured from the group consisting of fibers or films of polyamides, polyimides, polyamideimides, polybenzimidizoles, polyesters, fiberglass and biopolymers.

120. The gaskets of claim 119, wherein said epoxides are filled with at least one of the group consisting of: fibers, films, or particles of; ceramics, ceramers, tungsten carbide, silicon carbide, silica including silane bonding agents, silicone polymers, E-glass, polybenzimidizoles, polyetheretherketones, polysulfones, polyetherimides, and fluoropolymers.

121. The gaskets of claims 117-119, wherein at least one layer includes said inner portion with a cigarette wrapped polyamide having voids filled with said filled epoxides.

122. The gaskets of claim 121, wherein at least one layer exists within said inner portion that is covered but not wrapped around with a woven or non-woven polyamide cloth having voids either pre-filled or post-filled with said epoxides.

123. The gaskets of claim 122, wherein at least one layer exists within said inner portion that is covered by filament wound polyamide fibers having voids either pre-filled or post-filled with said epoxides.

124. The MWD sub-assemblies of claims 117-123, wherein said polyamide is Kevlar®.

125. The MWD sub-assemblies of claim 117, wherein said inner portion comprises a single non-conductive homogenous material layer.

126. The MWD sub-assemblies of claim 117, wherein said inner portion comprises a single non-conductive non-homogenous material layer.

127. The sub-assemblies of claim 117, wherein said inner portion comprises a single conductive homogenous material layer.

128. The sub-assemblies of claim 117, wherein said inner portion comprises a single conductive non-homogenous material layer.

129. The sub-assemblies of claim 117, wherein said total thickness of said gaskets is no greater than the diameter of a sealing groove in each half pipe-joint creating a full joint when mated by said gaskets, wherein said sealing groove is located between two sections of said sub-assembly assembly.

130. The sub-assemblies of claim 117, wherein said top and bottom gasket section and said inner portion of said gaskets are comprised of one or more non-conductive inorganic materials.

131. The sub-assemblies of claim 117, wherein said top and bottom gasket section and said inner portion of said gaskets are comprised of one or more non-conductive organic materials.

132. The sub-assemblies of claim 117, wherein said top and bottom gasket section is configured such that the outer dimensions of at least said top and bottom surface portion exceeds that of said inner portion of said gaskets.

133. The sub-assemblies of claim 117, wherein said top and bottom gasket section is beveled along at least one outer edge of said top and/or bottom gasket section.

134. The sub-assemblies of claim 117, wherein said top and bottom gasket section are compressed toward each other; both upon mating with and insertion within at least two sections of said sub-assemblies while said sub-assemblies are either at rest or in motion.

135. The sub-assemblies of claim 117, wherein said non-conductive materials are anodized metal oxide(s) formed from a metal or metal alloy, the anodization of which can be established by treating said top and bottom surface metal portion of said gaskets.

136. The sub-assemblies of claim 117, wherein said anodized metal oxide(s) are formed by anodized spraying, plasma etching, and/or oxidation exposure techniques of top and bottom metal gasket sections.

138. The sub-assemblies of claim 135, wherein said non-conductive materials comprise one or more layers of a ceramic or an inorganic composite material such as a ceramer.

139. The sub-assemblies of claim 117, wherein said inner portion of said gaskets is comprised of only insulated metal rings.

140. The sub-assemblies of claim 117, wherein said sealing ring with said top and bottom gasket section along with said top and bottom surface portion include at least one diameter having dimensions greater than said inner portion of said sealing ring.

141. One or more non-conductive multi-layered ringed spacer gaskets for mating one or more jointed sub-assemblies comprising:
at least two mutually joined ring-shaped bodies, said bodies each having a top surface portion, a top gasket section bonded with, adhered to, or part of said top surface portion, a bottom surface portion, and a bottom gasket section bonded with, adhered to, or part of said bottom surface portion wherein said bottom surface portion of one of said bodies is mated to a top surface portion of another of said bodies forming multi-layers;
whereby;
said at least two mutually joined ringed-shaped bodies in combination comprise a sealing ring so that said top and bottom gasket section along with said top and bottom surface portion have equal dimensioned outer diameters with a total thickness no greater than the diameter of said sub-assemblies in each joint half-mated by said gaskets;
and wherein said top and bottom gasket section of said ringed spacer gasket are comprised of a metal and wherein said top and bottom gasket section is separated by an inner portion that is comprised of one or more layers which are interlayered with conductive materials wherein said conductive materials are in combination with a top and bottom surface of said inner portion that is ductile but does not flow during dynamic motion and forces associated with said motion of said one or more jointed sub-assemblies;
and wherein said sealing ring is adapted for pressure-tight joining of MWD sub-assembly elements and exhibits full metal ductility withstanding compressive, tensile, shear and/or torsional forces greater than or equal to that of dynamic compressive, tensile, shear and/or torsional strength of said one or more jointed sub-assemblies.

142. The gaskets of claim 141, wherein at least one layer includes said inner portion with continuous toroidal axially and radially wrapped fibers having voids filled with adhesives such that shear forces occurring during movement of said sub-assemblies are distributed predominantly radially along the axial length of said polyamide fibers, thereby forcing said fibers to distribute load in the tensile direction and eliminating cracking of said gaskets.

143. The gaskets of claim 141, wherein at least one layer includes said inner portion that is wrapped in a toroidal pattern with a prepreg filled with said adhesives, wherein said adhesives are epoxides, and wherein said prepeg or fabric is manufactured from the group consisting of fibers or films of polyamides, polyimides, polyamideimides, polybenzimidizoles, polyesters, fiberglass and biopolymers.

144. The gaskets of claim 143, wherein said epoxides are filled with at least one of the group consisting of: fibers, films, or particles of; ceramics, ceramers, tungsten carbide, silicon carbide, silica including silane bonding agents, silicone polymers, E-glass, polybenzimidizoles, polyetheretherketones, polysulfones, polyetherimides, and fluoropolymers.

145. The gaskets of claim 141, wherein at least one layer includes said inner portion with a cigarette wrapped polyamide having voids filled with said filled epoxides.

146. The gaskets of claim 141, wherein at least one layer exists within said inner portion that is covered but not wrapped around with a woven or non-woven polyamide cloth having voids either pre-filled or post-filled with said epoxides.

147. The gaskets of claim 141, wherein at least one layer exists within said inner portion that is covered by filament wound polyamide fibers having voids either pre-filled or post-filled with said epoxides.

148. The gaskets of claims 141-147, wherein said polyamide is Kevlar®.

149. The gaskets of claim 141, wherein said inner portion comprises a single non-conductive homogenous material layer.

150. The gaskets of claim 141, wherein said inner portion comprises a single non-conductive non-homogenous material layer.

151. The gaskets of claim 141, wherein said inner portion comprises a single conductive homogenous material layer.

152. The gaskets of claim 141, wherein said inner portion comprises a single conductive non-homogenous material layer.

153. The gaskets of claim 141, wherein said total thickness is no greater than the diameter of a sealing groove in each half-joint creating a full joint when mated by said gaskets, wherein said sealing groove is located between two sections of said sub-assemblies.

154. The gaskets of claim 141, wherein said top and bottom gasket section and said inner portion of said gaskets are comprised of one or more non-conductive inorganic materials.

155. The gaskets of claim 141, wherein said top and bottom gasket section and said inner portion of said gasket are comprised of one or more non-conductive organic materials.

156. The gaskets of claim 141, wherein said top and bottom gasket section is configured such that the outer dimensions of at least said top and bottom surface portion exceeds that of said inner portion of said gaskets.

157. The gaskets of claim 141, wherein said top and bottom gasket section is beveled along at least one outer edge of said top and/or bottom gasket section.

158. The gaskets of claim 141, wherein said top and bottom gasket section are compressed toward each other; both upon mating with and insertion within at least two sections of said sub-assemblies while said sub-assemblies are either at rest or in motion.

159. The gaskets of claim 141, wherein said non-conductive materials are anodized metal oxide(s) formed from a metal or metal alloy, the anodization of which can be established by treating said top and bottom surface metal portion of said gaskets.

160. The gaskets of claim 141, wherein said anodized metal oxide(s) are formed by anodized spraying, plasma etching, and/or oxidation exposure techniques of top and bottom metal gasket sections.

161. The gaskets of claim 159, wherein said non-conductive materials comprise one or more layers of a ceramic or an inorganic composite material such as a ceramer.

162. The method of claim 141, wherein said inner portion is comprised of only insulated metal rings.

163. The method of claim 141, wherein said sealing ring with said top and bottom gasket section along with said top and bottom surface portion include at least one diameter having dimensions greater than said inner portion of said sealing ring.

164. A method of mating one or more MWD sub-assembly joints using one or more non-conductive ringed spacer gaskets for one or more sub-assemblies comprising:
having at least two sections of one or more sub-assemblies, one section of which comprises either an insulative pin portion and/or an insulative box portion;
wherein said gaskets have at least two mutually joined ring-shaped bodies, said bodies each with a top surface portion, a top gasket section bonded with, adhered to, or part of said top surface portion, a bottom surface portion, and a bottom gasket section bonded with, adhered to, or part of said bottom surface portion wherein said bottom surface portion of one of said bodies is being mated to a top surface portion of another of said bodies forming multi-layers;
whereby;
said at least two mutually joined ringed-shaped bodies in combination comprise a sealing ring so that said top and bottom gasket section along with said top and bottom surface portion have equal dimensioned outer diameters with a total thickness no greater than the diameter of said sub-assemblies in each joint half-mated by said gaskets;
and wherein said top and bottom gasket section of said ringed spacer gaskets is comprised of a metal or a non-metal such as a ceramic or ceramer and wherein said top and bottom gasket section is separated by an inner portion that is comprised of one or more materials that can be either conductive or non-conductive and wherein said materials being in combination with a top and bottom surface of said inner portion are ductile but do not flow during moving of said sub-assemblies causing dynamic motion and forces associated with said motion of said one or more MWD sub-assembly joints;
and wherein adapting said sealing ring for pressure-tight joining of MWD sub-assembly elements is allowing and exhibiting full metal ductility withstanding compressive, tensile, shear and/or torsional forces greater than or equal to that of dynamic compressive, tensile, shear and/or torsional strength of said one or more MWD sub-assembly joints by;
placing and attaching said ringed spacer gasket between said pin portion and said box portion of one or more MWD sub-assembly joints during mating of said sub-assemblies;
mating each of the joint halves into a single joint thereby sealing said one or more MWD sub-assembly joints.

165. The method of claim 164, wherein at least one layer includes said inner portion with continuous toroidal axially and radially wrapped polyamide fibers having voids filled with ceramic-filled epoxides such that shear forces occurring during movement of said sub-assemblies are distributed predominantly radially along the axial length of said polyamide fibers, thereby forcing said fibers to distribute load in the tensile direction and eliminating cracking of said gaskets.

166. The method of claim 164, wherein at least one layer includes said inner portion with continuous toroidal axially and radially wrapped fibers having voids filled with adhesives such that shear forces occurring during movement of said sub-assemblies are distributed predominantly radially along the axial length of said polyamide fibers, thereby forcing said fibers to distribute load in the tensile direction and eliminating cracking of said gaskets.

167. The method of claim 164, wherein at least one layer includes said inner portion that is wrapped in a toroidal pattern with a prepreg filled with said adhesives, wherein said adhesives are epoxides, and wherein said prepeg or fabric is manufactured from the group consisting of fibers or films of polyamides, polyimides, polyamideimides, polybenzimidizoles, polyesters, fiberglass and biopolymers.

168. The method of claim 167, wherein said epoxides are filled with at least one of the group consisting of: fibers, films, or particles of; ceramics, ceramers, tungsten carbide, silicon carbide, silica including silane bonding agents, silicone polymers, E-glass, polybenzimidizoles, polyetheretherketones, polysulfones, polyetherimides, and fluoropolymers.

169. The method of claim 165, wherein at least one layer exists within said inner portion that is covered but not wrapped around with a woven or non-woven polyamide cloth having voids either pre-filled or post-filled with said epoxides.

170. The method of claim 169, wherein at least one layer exists within said inner portion that is covered by filament wound polyamide fibers having voids either pre-filled or post-filled with said epoxides.

171. The method of claims 164-170, wherein said polyamide is Kevlar®.

172. The method of claim 164, wherein said inner portion comprises a single non-conductive homogenous material layer.

173. The method of claim 164, wherein said inner portion comprises a single non-conductive non-homogenous material layer.

174. The method of claim 164, wherein said inner portion comprises a single conductive homogenous material layer.

175. The method of claim 164, wherein said inner portion comprises a single conductive non-homogenous material layer.

176. The method of claim 164, wherein said total thickness is no greater than the diameter of a sealing groove in each half-joint creating a full joint when mated by said gasket, wherein said sealing groove is located between two sections of said MWD sub-assembly.

177. The method of claim 164, wherein said top and bottom gasket section and said inner portion of said gasket are comprised of one or more non-conductive inorganic materials.

178. The method of claim 164, wherein said top and bottom gasket section and said inner portion of said gasket are comprised of one or more non-conductive organic materials.

179. The method of claim 164, wherein said top and bottom gasket section is configured such that the outer dimensions of at least said top and bottom surface portion exceeds that of said inner portion of said gasket.

180. The method of claim 164, wherein said top and bottom gasket section is beveled along at least one outer edge of said top and/or bottom gasket section.

181. The method of claim 164, wherein said top and bottom gasket section are compressed toward each other; both upon mating with and insertion within at least two sections of said MWD sub-assemblies while said MWD sub-assemblies are either at rest or in motion.

182. The method of claim 164, wherein said non-conductive materials are anodized metal oxide(s) formed from a metal or metal alloy, the anodization of which can be established by treating said top and bottom surface metal portion of said gaskets.

183. The method of claim 164, wherein said anodized metal oxide(s) are formed by anodized spraying, plasma etching, and/or oxidation exposure techniques of top and bottom metal gasket sections.

184. The gasket of claim 182, wherein said non-conductive materials comprise one or more layers of a ceramic or an inorganic composite material such as a ceramer.

185. The method of claim 182, wherein said inner portion is comprised of only insulated metal rings.

186. The method of claim 164, wherein said sealing ring with said top and bottom gasket section along with said top and bottom surface portion include at least one diameter having dimensions greater than said inner portion of said sealing ring.

187. The ringed spacer gaskets of claims 94 and 117 wherein said gaskets are provided between one or more flanged jointed MWD sub-assemblies.
